(19) United States
(12) Patent Application Publication
(10) Pub. No.: US 2021/0214599 A1
(43) Pub. Date: Jul. 15, 2021

(54) LATENT HEAT STORAGE MATERIAL AND A METHOD OF MANUFACTURING SAME, AND COLD STORAGE PACK, LOGISTIC PACKAGING CONTAINER, HUMAN BODY COOLING TOOL, REFRIGERATOR, AND FOOD COOLING TOOL ALL CONTAINING SAME

(71) Applicant: SHARP KABUSHIKI KAISHA, Sakai City, Osaka (JP)

(72) Inventors: SATORU MOTONAMI, Sakai City, Osaka (JP); MASAKAZU KAMURA, Sakai City, Osaka (JP); YUKA UTSUMI, Sakai City, Osaka (JP); KYOHEI SEZUKURI, Sakai City, Osaka (JP)

(21) Appl. No.: 15/734,112

(22) PCT Filed: Jun. 4, 2019
(86) PCT No.: PCT/JP2019/022138

§ 371 Date: Dec. 1, 2020

(30) Foreign Application Priority Data
Jun. 7, 2018 (JP) 2018-109550

(51) Int. Cl. C09K 5/06; F25D 3/00

(52) U.S. Cl. CPC C09K 5/063; F25D 2303/085; F25D 3/00

(57) ABSTRACT

There is provided a latent heat storage material that retains the cold insulation capability thereof and is still restrained from supercooling. The latent heat storage material includes: quaternary ammonium ions and first anions that together form a quaternary ammonium salt; water; and calcium carbonate, wherein the quaternary ammonium salt and the water can form a clathrate hydrate, the quaternary ammonium salt and the water have a composition ratio in which the quaternary ammonium salt and the water can at least form the clathrate hydrate, and the calcium carbonate has an addition ratio relative to a mass of an aqueous solution that is the latent heat storage material excluding the calcium carbonate, the addition ratio being higher than a solubility of the calcium carbonate in the aqueous solution at an onset temperature of melting of the aqueous solution that is the latent heat storage material excluding the calcium carbonate.

### TECHNICAL FIELD

The present invention relates to latent heat storage materials and methods of manufacturing such a material and also to cold storage packs, logistic packaging containers, human body cooling tools, refrigerators, and food cooling tools all containing the material.

The present application claims priority to Japanese Patent Application, Tokugan, No. 2018-109550 filed in Japan on Jun. 7, 2018, which is incorporated herein by reference in its entirety.

### BACKGROUND ART

Commercial and other articles that need to be kept at certain temperature for quality preservation purposes have been conventionally kept in a temperature range that is suitable for the articles during transport. For example, in transporting food, the food needs to be stored, managed, and transported at a suitable temperature so that the food remains fresh.

Various foods are typically transported after the foods are collected from producers and sorted for individual customers for dispatch. The foods may be stored in a refrigeration room (cold warehouse) in that process.

Meanwhile, when food articles need to be stored in locations where there is no electrical facility available during transport or transported in a vehicle with no electrical facility, the food articles are typically placed in a thermally insulated container together with cold storage material so that the food articles are keep at low temperature by the cold storage material.

A known source for such a cold storage material is semi-clathrate hydrates of quaternary ammonium salts (see, for example, Patent Literature 1). Semi-clathrate hydrates of quaternary ammonium salts are useful because these hydrates are non-combustible and almost harmless to the human body.

Meanwhile, the cold storage material composed primarily of a semi-clathrate hydrate of a quaternary ammonium salt will likely undergo supercooling upon freezing and may not often solidify when the cold storage material is cooled to the onset temperature of melting thereof.

Patent Literature 2 attempts to address such a problem by restraining or preventing the supercooling of a thermal storage material (cold storage material) containing a semi-clathrate hydrate of a quaternary ammonium salt.

Patent Literature 2 discloses a thermal storage material (cold storage material) prepared by adding disodium hydrogen phosphate to an aqueous solution containing a quaternary ammonium salt.

The growth (production) rate of the semi-clathrate hydrate of a quaternary ammonium salt during cooling is greater in an aqueous solution containing a quaternary ammonium salt and disodium hydrogen phosphate than in an aqueous solution containing a quaternary ammonium salt, but no disodium hydrogen phosphate. This mechanism can restrain or prevent the supercooling of a thermal storage material containing a semi-clathrate hydrate of a quaternary ammonium salt.

### CITATION LIST

### Patent Literature

### Patent Literature 1: Japanese Unexamined Patent Application Publication, Tokukaihei, No. 9-291272

### Patent Literature 2: Japanese Unexamined Patent Application Publication, Tokukai, No. 2008-214527

### SUMMARY OF INVENTION

### Technical Problem

Patent Literature 2 confirms that disodium hydrogen phosphate is soluble in an aqueous solution containing a quaternary ammonium salt at temperature from 4 to 12° C. Accordingly, the anions of a quaternary ammonium salt and the anions of disodium hydrogen phosphate can be exchanged so as to reduce the production of the desired quaternary ammonium salt and promote the production of other quaternary ammonium salts. These phenomena may reduce the amount of stored heat (amount of latent heat) in this type of thermal storage material and lower the onset temperature of melting of the desired semi-clathrate hydrate of a quaternary ammonium salt. This type of thermal storage material hence has a problem of insufficient thermal storage capability (cold insulation capability).

The present invention, in an aspect thereof, has been made in view of these issues and has an object to provide a latent heat storage material that retains the cold insulation capability thereof and is still restrained from supercooling, a method of manufacturing such a latent heat storage material, and a cold storage pack, a logistic packaging container, a human body cooling tool, a refrigerator, and a food cooling tool all containing the material. The cold insulation capability is evaluated in terms of the onset temperature of melting and the amount of latent heat throughout the present specification.

### Solution to Problem

To address these problems, the present invention, in an aspect thereof, provides a latent heat storage material containing: quaternary ammonium ions and first anions that together form a quaternary ammonium salt; water, and calcium carbonate, wherein the quaternary ammonium salt and the water can form a clathrate hydrate, the quaternary ammonium salt and the water have a composition ratio in which the quaternary ammonium salt and the water can at least form the clathrate hydrate, and the calcium carbonate has an addition ratio relative to a mass of an aqueous solution that is the latent heat storage material excluding the calcium carbonate, the addition ratio being higher than a solubility of the calcium carbonate in the aqueous solution at an onset temperature of melting of the aqueous solution that is the latent heat storage material excluding the calcium carbonate.

In another aspect of the present invention, the quaternary ammonium salt may be at least one compound selected from the group consisting of tetrabutylammonium fluoride, tetrabutylammonium bromide, tetrabutylammonium chloride, and tetrabutylammonium nitrate.

In yet another further aspect of the present invention, the calcium carbonate may have an addition ratio of at least 0.1 mass % relative to a sum of the quaternary ammonium salt and the water.

In still another aspect of the present invention, the quaternary ammonium salt may be tetrabutylammonium bromide, and the calcium carbonate may have an addition ratio of at least 0.1 mass % relative to a sum of the tetrabutylammonium bromide and the water.

In yet still another aspect of the present invention, the latent heat storage material may further contain metal ions (M⁺) and second anions (Xⁿ⁻) that together form an inorganic salt of formula (1), wherein the inorganic salt has a molar ratio of from 0.1 to 10, both inclusive, relative to the quaternary ammonium salt:

M⁺ₙXⁿ⁻ (1)

where M⁺ represents K⁺, Rb⁺, or Cs⁺, and Xⁿ⁻ represents F⁻, Cl⁻, Br⁻, I⁻, NO₃⁻, or PO₄³⁻.

In further aspect of the present invention, the second anions may be at least one type of ions selected from the group consisting of fluoride ions, chloride ions, bromide ions, iodide ions, and nitrate ions.

In yet a further aspect of the present invention, the metal ions may be potassium ions.

In still a further aspect of the present invention, the quaternary ammonium salt may be tetrabutylammonium bromide, the inorganic salt may be potassium bromide, and the calcium carbonate may have an addition ratio of at least 0.1 mass % relative to a sum of the tetrabutylammonium bromide, the water, and the potassium bromide.

In yet still a further aspect of the present invention, the quaternary ammonium salt may be tetrabutylammonium bromide, the inorganic salt may be potassium nitrate, and the calcium carbonate may have an addition ratio of at least 0.1 mass % relative to a sum of the tetrabutylammonium bromide, the water, and the potassium nitrate.

The present invention, in an additional aspect thereof, provides a cold storage pack containing the latent heat storage material described above; and at least one encasing section configured to encase the latent heat storage material therein in a liquid-tight manner.

In a further aspect of the present invention, the at least one encasing section may include a plurality of such encasing sections, and the cold storage pack may further include an articulation section configured to connect the plurality of encasing sections to each other.

The present invention, in a further aspect thereof, provides a logistic packaging container including the cold storage pack described above.

In a further aspect of the present invention, the logistic packaging container may further include a holding member configured to hold the cold storage pack.

The present invention, in a further aspect thereof, provides a logistic packaging container including the cold storage pack described above.

The present invention, in a further aspect thereof, provides a human body cooling tool including the cold storage pack described above.

The present invention, in a further aspect thereof, provides a food cooling tool including the cold storage pack described above.

The present invention, in a further aspect thereof, provides a refrigerator including the cold storage pack described above.

The present invention, in a further aspect thereof, provides a method of manufacturing a latent heat storage material, the method including mixing an aqueous solution of a carbonate salt and an aqueous solution of a calcium salt, wherein either one or both of the aqueous solution of a carbonate salt and the aqueous solution of a calcium salt contain(s) a quaternary ammonium salt.

In a further aspect of the present invention, the carbonate salt may be an inorganic salt of formula (2), and the calcium salt may be an inorganic salt of formula (3):

M⁺₂CO₃²⁻ (2)

Ca²⁺_{(n/2)}Xⁿ⁻ (3)

where M⁺ in formula (1) represents K⁺, Rb⁺, or Cs⁺, and Xⁿ⁻ in formula (2) represents F⁻, Cl⁻, Br⁻, I⁻, NO₃⁻, or PO₄³⁻.

### Advantageous Effects of Invention

The present invention, in an aspect thereof, provides a latent heat storage material that retains the cold insulation capability thereof and is still restrained from supercooling, a method of manufacturing such a latent heat storage material, and a cold storage pack, a logistic packaging container, a human body cooling tool, a refrigerator, and a food cooling tool all containing the material.

### BRIEF DESCRIPTION OF DRAWINGS

FIG. 1 is a plan view of a cold storage pack 100 in accordance with a third embodiment.

FIG. 2 is a cross-sectional view related to FIG. 1.

FIG. 3 is a conceptual drawing illustrating steps of manufacturing the cold storage pack 100 in accordance with the third embodiment.

FIG. 4 is a cross-sectional view of a logistic packaging container 200 in accordance with the third embodiment.

FIG. 5 is a cross-sectional view of a logistic packaging container (variation example) 200A in accordance with the third embodiment.

FIG. 6 is a cross-sectional view of a logistic packaging container (variation example) 200B in accordance with the third embodiment.

FIG. 7 is a cross-sectional view of a logistic packaging container (variation example) 200C in accordance with the third embodiment.

FIG. 8 is a perspective view of a cold storage pack 400 in accordance with a fourth embodiment.

FIG. 9 is a cross-sectional view taken along line IX-IX shown in FIG. 8.

FIG. 10 is a schematic diagram of a structure of apparatus used in manufacturing the cold storage pack 400 in accordance with the fourth embodiment.

FIG. 11 is a cross-sectional view of a logistic packaging container 500 in accordance with the fourth embodiment.

FIG. 12 is a cross-sectional view of a logistic packaging container (variation example) 500A in accordance with the third embodiment.

FIG. 13 is a plan view of a cold storage pack 300 in accordance with a fifth embodiment.

FIG. 14 is a cross-sectional view related to FIG. 13.

FIG. 15 is a perspective view of a cold storage pack (variation example) 300A in accordance with the fifth embodiment.

FIG. 16 is a conceptual drawing showing how to use the cold storage pack 300A in accordance with the fifth embodiment.

FIG. 17 is a conceptual drawing illustrating steps of manufacturing the cold storage pack 300 in accordance with the fifth embodiment.

FIG. 18 is a cross-sectional view of a logistic packaging container 700 in accordance with the fifth embodiment.

FIG. 19 is a conceptual drawing showing how to use a food cooling tool 600 in accordance with a sixth embodiment.

FIG. 20 is a conceptual drawing showing how to use a human body cooling tool 900 in accordance with a seventh embodiment.

FIG. 21 is a cross-sectional view of a refrigerator 800 in accordance with an eighth embodiment.

### DESCRIPTION OF EMBODIMENTS

### First Embodiment

### Latent Heat Storage Material

The following will describe a latent heat storage material in accordance with a first embodiment.

A latent heat storage material in accordance with the present embodiment contains: quaternary ammonium ions and first anions that may form a quaternary ammonium salt; water, and calcium carbonate.

Starting materials for the latent heat storage material in accordance with the present embodiment are not necessarily limited to a quaternary ammonium salt, calcium carbonate, and water.

The hydrate of a quaternary ammonium salt is a semi-clathrate hydrate containing water molecules as a host compound (host molecules) and quaternary ammonium cations as a guest compound (guest molecules).

A clathrate hydrate is a crystallized compound of a basket-like structure formed by the hydrogen bonds of water molecules (host molecules), the basket-like structure holding therein a gas or like molecule (guest molecule) of a relatively small molecular size (molecular weight of 200 or less) such as tetrahydrofuran or cyclohexane.

Meanwhile, a semi-clathrate hydrate is a crystallized compound of a basket-like structure formed by the hydrogen bonds of water molecules (host molecules), the basket-like structure enwrapping therein a guest molecule of a relatively large molecular size such as a tetraalkylammonium cation in such a manner as to circumvent the alkyl chain of the tetraalkylammonium cation.

The basket-like structure formed by the hydrogen bonds of a semi-clathrate hydrate enwraps therein a guest molecule of a relatively large molecular size as described here. The crystal therefore has a structure where the basket-like structure formed by the hydrogen bonds of water molecules is partially broken, and the cations in the guest molecules are enclathrated in baskets, whereas the anions therein replace water molecules in the baskets. The crystal is hence called a semi-clathrate hydrate. Tetraalkylammonium salt is known as a typical compound that can form a semi-clathrate hydrate.

Cations of organic salt typically such as tetraalkylamine salt and tetraalkyl phosphine salt are known to serve as guest molecules in a semi-clathrate hydrate.

Throughout the following description, the “clathrate hydrate” includes the “semi-clathrate hydrate.”

A clathrate hydrate of a quaternary ammonium salt is known to form at normal pressure and generate heat during the formation thereof, and on the other hand, known to absorb heat during the dissociation thereof. A latent heat storage material in accordance with the present embodiment can utilize the heat generated or absorbed by a clathrate hydrate of a quaternary ammonium salt during the formation and dissociation thereof as latent heat.

The formation and dissociation of a clathrate hydrate resembles a solid-to-liquid phase transition (e.g., from ice to water).

For this reason, the formation of a clathrate hydrate may be referred to as solidification or freezing in this specification.

The temperature at which a clathrate hydrate starts to solidify may be referred to as the onset temperature of solidification.

The dissociation of a clathrate hydrate may be referred to as melting in this specification.

The temperature at which a clathrate hydrate starts to melt may be referred to as the onset temperature of melting.

It will be detailed later how the onset temperature of solidification and the onset temperature of melting are measured.

A quaternary ammonium salt is preferably at least one compound selected from the group consisting of tetrabutylammonium fluoride (“TBAF”), tetrabutylammonium bromide (“TBAB”), tetrabutylammonium chloride (“TBAC”), and tetrabutylammonium nitrate (“TBAN”), more preferably at least one compound selected from the group consisting of TBAB, TBAC, and TBAN, and even more preferably TBAB.

A quaternary ammonium salt and water have a composition ratio the quaternary ammonium salt and water in which can at least form a clathrate hydrate.

A quaternary ammonium salt and water may alternatively have a composition ratio the quaternary ammonium salt and water in which form a clathrate hydrate that has a congruent melting point. A latent heat storage material having “the composition ratio thereof adjusted to a concentration at which the clathrate hydrate has a congruent melting point” has a melting point that is equal to the temperature defined as the equilibrium temperature between the solid phase and the liquid phase.

For instance, TBAB is said to have two concentrations at which the TBAB comes to have a congruent melting point. One of the concentrations is approximately 40 mass %, and the other is approximately 32 mass %. A TBAB clathrate hydrate is termed the first hydrate when the hydrate has the composition ratio thereof adjusted to approximately 40 mass % and the second hydrate when the hydrate has the composition ratio thereof adjusted to approximately 32 mass %. The first hydrate of TBAB has a melting point of around 12° C., and the second hydrate of TBAB has a melting point of around 9.9° C.

TBAB can however serve as a latent heat storage material because TBAB forms a mixture of the first hydrate and the second hydrate when TBAB has a composition ratio that is lower than the concentration at which TBAB has a congruent melting point. When TBAB has a composition ratio that is higher than the concentration at which TBAB has a congruent melting point, TBAB can still serve as a latent heat storage material.

When a quaternary ammonium salt is at an even lower concentration, the latent heat storage material may have a melting point of 0° C. attributable to ice and another melting point of 0° C. or higher that is a melting point of the semi-clathrate hydrate, in which case, TBAB can still serve as a latent heat storage material.

In an aspect, the latent heat storage material contains TBAF as a quaternary ammonium salt and further contains preferably 25 to 35 moles, more preferably 27 to 33 moles, and even more preferably 29 to 33 moles of water molecules for each TBAF molecule.

In another aspect, the latent heat storage material contains TBAB as a quaternary ammonium salt and further contains preferably 22 to 42 moles, more preferably 24 to 30 moles, and even more preferably 26 to 30 moles of water molecules for each TBAB molecule.

In a further aspect, the latent heat storage material contains TBAC as a quaternary ammonium salt and further contains preferably 26 to 36 moles, more preferably 28 to 34 moles, and even more preferably 30 to 34 moles of water molecules for each TBAC molecule.

In still another aspect, the latent heat storage material contains TBAN as a quaternary ammonium salt and further contains preferably 22 to 32 moles, more preferably 24 to 30 moles, and even more preferably 26 to 30 moles of water molecules for each TBAN molecule.

The clathrate hydrate of a quaternary ammonium salt is believed to form a crystalline compound when the hydrate is in the solid state. X-ray diffraction (XRD) measurement on a latent heat storage material in accordance with the present embodiment can verify that the latent heat storage material contains such a crystalline compound by observing X-ray diffraction peaks to find an X-ray diffraction peak that is at least not attributable to ice.

XRD measurement is conducted in the present specification using X-ray diffraction apparatus equipped with a temperature control function. The XRD measurement on a latent heat storage material uses an X-ray diffraction pattern thereof that is obtained when the latent heat storage material is in the solid state after being solidified through the temperature control function.

As a source for a cold storage material, paraffin-based compounds such as tetradecane are flammable or combustible, but a clathrate hydrate of a quaternary ammonium salt is non-combustible. It is therefore easier to handle a clathrate hydrate of a quaternary ammonium salt.

Meanwhile, a clathrate hydrate of a quaternary ammonium salt may not solidify unless the hydrate is cooled to a temperature lower than the onset temperature of melting thereof (“supercooling”). For instance, when the quaternary ammonium salt is TBAB, the TBAB clathrate hydrate has an onset temperature of melting of 11.9° C., but an onset temperature of solidification of −3° C.

The inventors have diligently worked and found that calcium carbonate promotes the formation of a clathrate hydrate of a quaternary ammonium salt with no significant changes to the cold insulation capability of the clathrate hydrate, in other words, with no significant changes to the onset temperature of melting and the amount of latent heat thereof. Calcium carbonate is poorly soluble in water. Specifically, calcium carbonate has a solubility of 0.0015 grams at 20° C.

The “solubility” in the present specification is the concentration of a solute in a saturated aqueous solution and expressed in terms of the mass of the solute in 100 grams of water.

Most calcium carbonate in the latent heat storage material in accordance with the present embodiment therefore precipitates and serves as a nucleus in the formation of a clathrate hydrate of a quaternary ammonium salt. Because a very small amount of calcium carbonate is dissolved in the aqueous solution containing a quaternary ammonium salt, the cold insulation capability of the latent heat storage material would unlikely deteriorate due to exchange of salt between the quaternary ammonium salt and calcium carbonate.

The nucleation of a clathrate hydrate in a latent heat storage material in accordance with the present embodiment is believed to occur on the surface of a supercooling inhibitor (calcium carbonate) in a non-uniform manner. This non-uniform nucleation is known to more likely occur with higher wettability between the clathrate hydrate and the surface of the supercooling inhibitor.

The inventors have diligently worked and found that calcium carbonate is an effective supercooling inhibitor for the clathrate hydrate because water has high wettability with respect to calcium carbonate, in other words, water has a small contact angle.

A commonly known source for a cold storage material is sugar alcohol. The contact angle of water on calcium carbonate was compared with the contact angle of a pseudo-sugar alcohol on calcium carbonate by using ethylene glycol, which exhibit properties equivalent to those of a sugar alcohol, as a pseudo-sugar alcohol and using water as a pseudo-clathrate hydrate.

Specifically, water and a pseudo-sugar alcohol were dispensed dropwise on pellets of calcium carbonate to evaluate the contact angles of water and the pseudo-sugar alcohol on the pellets. The experiment demonstrated that water has a smaller contact angle than the pseudo-sugar alcohol.

Supercooling inhibiting effect was analyzed on a latent heat storage material in accordance with the present embodiment and on a latent heat storage material containing the pseudo-sugar alcohol and additional calcium carbonate. The analysis demonstrated that the latent heat storage material in accordance with the present embodiment shows a supercooling inhibiting effect and that in contrast, the latent heat storage material containing the pseudo-sugar alcohol shows no supercooling inhibiting effect.

From these results, it is envisaged that calcium carbonate in the latent heat storage material in accordance with the present embodiment has a good supercooling inhibiting effect not only because calcium carbonate is poorly soluble in water, but also because water has a small contact angle on calcium carbonate and promotes the nucleation of the clathrate hydrate on the surface of calcium carbonate.

The addition ratio of calcium carbonate in the present embodiment is higher than the solubility of calcium carbonate in an aqueous solution that is the latent heat storage material excluding the calcium carbonate at the onset temperature of melting of the aqueous solution. In other words, the addition ratio of calcium carbonate in the present embodiment is a ratio at which the calcium carbonate added at least partially precipitates at the onset temperature of melting thereof. The surface of the precipitated calcium carbonate promotes the non-uniform nucleation of a clathrate hydrate of a quaternary ammonium salt, thereby restraining supercooling.

The “addition ratio” in the present specification is the percentage of the mass of the calcium carbonate added to the latent heat storage material relative to the mass of the aqueous solution that is the latent heat storage material excluding the calcium carbonate. The aqueous solution that is the latent heat storage material excluding the calcium carbonate may be referred to as the “base material.”

For instance, the addition ratio of calcium carbonate is preferably from 0.1 mass % to 10 mass % relative to the sum of the quaternary ammonium salt and water.

When the addition ratio of calcium carbonate is 0.1 mass % or higher, a sufficient amount of calcium carbonate to restrain supercooling precipitates at the onset temperature of melting of the latent heat storage material in accordance with the present embodiment, which freezes the clathrate hydrate in a stable manner.

When the addition ratio of calcium carbonate is 10 mass % or less, a sufficient amount of latent heat per unit weight becomes available at the onset temperature of melting of the latent heat storage material in accordance with the present embodiment.

In yet another aspect, the quaternary ammonium salt is preferably TBAB in the latent heat storage material in accordance with the present embodiment, and the calcium carbonate preferably has an addition ratio of 1 mass % or higher relative to the sum of the TBAB and the water.

It is possible to verify by a publicly known method that the latent heat storage material in accordance with the present embodiment contains: quaternary ammonium ions and first anions that together form a quaternary ammonium salt; water; and calcium carbonate. Examples of such measurement methods include liquid chromatography (LC), mass spectrometry (MS), and ph test strips, all carried out on the latent heat storage material in the liquid state. Another exemplary method is to vaporize the water in the latent heat storage material in accordance with the present embodiment, for example, in an evaporator and then measure the resultant solid ingredients by X-ray diffraction (XRD), infrared spectroscopy, or nuclear magnetic resonance.

The latent heat storage material in accordance with the present embodiment may contain an additive other than the aforementioned substances, so long as the additive does not disrupt the effects of the present embodiment.

As an example, the latent heat storage material in accordance with the present embodiment may contain a thickening agent to adjust the viscosity of the latent heat storage material for ease in handling. Examples of such a thickening agent include xanthan gum, guar gum, carboxy methyl cellulose, and sodium polyacrylate.

The latent heat storage material in accordance with the present embodiment may contain an additional antibacterial agent for long-term usability. The additives for use in the present embodiment are not necessarily limited to the example substances described here.

The value obtained by the following method is used as the onset temperature of melting of the latent heat storage material in the present specification.

The value obtained by differential scanning calorimetry (DSC) is used as the onset temperature of melting of the latent heat storage material. Specifically, the latent heat storage material in the liquid state (approximately 4 milligrams) is enclosed in an aluminum pan prepared for DSC measurement. The enclosed latent heat storage material is cooled at a rate of 5° C./minute to change from the liquid state to the solid state, and then heated at a rate of 5° C./minute. An endothermic peak appears on the DSC curve when the latent heat storage material changes from the solid state to the liquid state in the heating. The onset temperature of melting is obtained as the intersection of the extrapolation of the rising portion of the endothermic peak and the extrapolation of the baseline of the endothermic peak.

The value obtained by the following method is used as the onset temperature of solidification of the latent heat storage material in the present specification.

Approximately 5 grams of the latent heat storage material is first weighed out and poured into a glass tube bottle. Temperature is measured at the center of the latent heat storage material in the glass tube bottle using a thermocouple. The glass tube bottle is placed in a thermostatic tank equipped with a temperature-varying function at room temperature. Next, the inside of the thermostatic tank is cooled at a prescribed rate. A graph representing temperature changes in the latent heat storage material is hence obtained with the horizontal axis representing the cooling time and the vertical axis representing the temperature of the latent heat storage material. These temperature changes may be referred to as solidification behavior. Next, in the obtained solidification behavior graph, the temperature at which heat generation is observed in the solidification of the latent heat storage material is taken as the onset temperature of solidification. Specifically, the temperature of the latent heat storage material is differentiated with respect to cooling time. The temperature (° C.) of the latent heat storage material at which the differential value goes from negative to positive for the first time in the measurement period is taken as the onset temperature of solidification.

The value obtained by the following method is used as the melting point of the latent heat storage material in the present specification.

Approximately 5 grams of the latent heat storage material is first weighed out and poured into a glass tube bottle. Temperature is measured at the center of the latent heat storage material in the glass tube bottle using a thermocouple. The glass tube bottle is placed in a thermostatic tank equipped with a temperature-varying function at room temperature. Next, the inside of the thermostatic tank is cooled to −20° C. to freeze the latent heat storage material therein and thereafter heated from −20° C. to 30° C. at a rate of 0.25° C./minute. A graph representing temperature changes in the latent heat storage material with respect to heating time is hence obtained with the start of the heating being plotted at zero hours. These temperature changes may be referred to as melting behavior.

Next, in the obtained melting behavior graph, the temperature of the latent heat storage material is differentiated with respect to heating time. The temperature of the latent heat storage material at the time when the differential value becomes equal to zero for the first time in the measurement period is denoted by T1 (° C.).

The temperature of the latent heat storage material at the time when the differential value becomes equal to zero for the last time in the measurement period is denoted by T2 (° C.).

A temperature between T1 (° C.) and T2 (° C.) is taken as the melting point.

The value obtained by dividing the area of the endothermic peak on the DSC curve by the mass of the sample is taken as the amount of latent heat per unit mass of the latent heat storage material.

### Method of Manufacturing Latent Heat Storage Material

The latent heat storage material in accordance with the present embodiment is manufactured by mixing a quaternary ammonium salt, water, and calcium carbonate in the above-described proportion. The quaternary ammonium salt, water, and calcium carbonate may be mixed in any order. For ease in controlling the mass of each substance, an aqueous solution of TBAB is preferably prepared in advance so that calcium carbonate can be added to this aqueous solution.

The present embodiment provides a latent heat storage material that retains the cold insulation capability thereof and is still restrained from supercooling.

### Second Embodiment

### Latent Heat Storage Material

The following will describe a latent heat storage material in accordance with a second embodiment.

A latent heat storage material in accordance with the second embodiment differs from the latent heat storage material in accordance with the first embodiment in that the former contains metal ions (M⁺) and second anions (Xⁿ⁻) that form an inorganic salt of formula (1).

M⁺ₙXⁿ⁻ (1)

In formula (1), M⁺ represents K⁺, Rb⁺, or Cs⁺, and Xⁿ⁻ represents F⁻, Cl⁻, Br⁻, I⁻, NO₃⁻, or PO₄⁻.

The material containing a quaternary ammonium salt, an inorganic salt, and water may form a crystalline compound in the solid state. It is possible to verify that the latent heat storage material in accordance with the present embodiment contains such a crystalline compound, by observing X-ray diffraction peaks in XRD measurement on the latent heat storage material.

The metal ions (M⁺) and the second anions (Xⁿ⁻) are ions the hydration of which is negative. The “ions the hydration of which is negative” are those ions around which water molecules stay for a shorter period of time when the water molecules move into contact with the ions than water molecules in pure water stay at equilibrium positions. Water molecules are in a disorderly state around the ions the hydration of which is negative. For this reason, the ions the hydration of which is negative are also referred to as structure-breaking ions. By mixing a salt of ions the hydration of which is negative, a quaternary ammonium salt, and water in a specific composition ratio, a crystalline compound is obtained that has a melting point that differs from all of the melting points of these three substances, the melting point of a eutectic mixture of the quaternary ammonium salt and water, the melting point of a eutectic mixture of the inorganic salt and water, and the melting point of a eutectic mixture of the inorganic salt and the quaternary ammonium salt.

It is possible to verify by the publicly known method described in the first embodiment that the latent heat storage material in accordance with the present embodiment contains the metal ions (M⁺) and the second anions (Xⁿ⁻) that together form an inorganic salt of formula (1) above.

The metal ions (M⁺) are preferably potassium ions.

The second anions (Xⁿ⁻) are preferably at least one type of ions selected from the group consisting of fluoride ions, chloride ions, bromide ions, iodide ions, and nitrate ions.

In an aspect, the inorganic salt is preferably potassium bromide or potassium nitrate.

In the latent heat storage material in accordance with the present embodiment, the molar ratio of the inorganic salt to the quaternary ammonium salt is from 0.1 to 10, both inclusive, preferably form 0.3 to 5, both inclusive, and more preferably from 0.5, inclusive, to 1.5, exclusive.

When the molar ratio of the inorganic salt to the quaternary ammonium salt is 0.1 or higher, the proportion of the eutectic mixture of the quaternary ammonium salt, the inorganic salt, and the water increases, and the proportion of the clathrate hydrate of the quaternary ammonium salt decreases, in the latent heat storage material in accordance with the present embodiment. The clathrate hydrate of the quaternary ammonium salt and the eutectic mixture of the quaternary ammonium salt, the inorganic salt, and the water have different onset temperatures of melting. The eutectic mixture of the quaternary ammonium salt, the inorganic salt, and the water therefore has an increased latent heat value at the onset temperature of melting thereof. This phenomenon facilitates cooling at the melting point of the eutectic mixture of the quaternary ammonium salt, the inorganic salt, and the water when the latent heat storage material in accordance with the present embodiment is used in a cold storage pack.

When the molar ratio of the inorganic salt to the quaternary ammonium salt is 10 or lower, the inorganic salt will less likely precipitate. The inorganic salt dissolved in the water functions as a latent heat storage material. Consequently, the eutectic mixture of the quaternary ammonium salt, the inorganic salt, and the water has an increased amount of latent heat at the onset temperature of melting thereof.

In another aspect, in the latent heat storage material in accordance with the present embodiment, the quaternary ammonium salt is TBAB, the inorganic salt is potassium bromide, and the molar ratio of the potassium bromide to the TBAB is from 0.5, inclusive, to 1.5, exclusive and preferably from 0.75 to 1.3 both inclusive.

In a further aspect, in the latent heat storage material in accordance with the present embodiment, the quaternary ammonium salt is TBAB, the inorganic salt is potassium nitrate, and the molar ratio of the potassium nitrate to the TBAB is preferably from 0.3 to 1.3, more preferably from 0.5 to 0.8, and even more preferably from 0.six to 0.8, all inclusive.

As an example, the addition ratio of the calcium carbonate is preferably from 0.1 mass % to 10 mass %, both inclusive, relative to the sum of the quaternary ammonium salt, the water, and the inorganic salt.

When the addition ratio of calcium carbonate is 0.1 mass % or higher, a sufficient amount of calcium carbonate to restrain supercooling precipitates at the onset temperature of melting of the latent heat storage material in accordance with the present embodiment.

When the addition ratio of calcium carbonate is 10 mass % or less, a sufficient amount of latent heat becomes available at the onset temperature of melting of the latent heat storage material in accordance with the present embodiment.

In still another aspect, in the latent heat storage material in accordance with the present embodiment, the quaternary ammonium salt is TBAB, the inorganic salt is potassium bromide, and the addition ratio of the calcium carbonate is preferably 0.1 mass % or higher and more preferably 1 mass % or higher relative to the sum of the TBAB, the water, and the potassium bromide.

In yet another aspect, in the latent heat storage material in accordance with the present embodiment, the quaternary ammonium salt is TBAB, the inorganic salt is potassium nitrate, and the addition ratio of the calcium carbonate is preferably 0.1 mass % or higher and more preferably 1 mass % or higher relative to the sum of the TBAB, the water, and the potassium nitrate.

Method of Manufacturing Latent Heat Storage Material The following will describe an example of a method of manufacturing the latent heat storage material in accordance with the present embodiment.

A method of manufacturing the latent heat storage material in accordance with the present embodiment involves a step of mixing an aqueous solution of a carbonate salt and an aqueous solution of a calcium salt.

The inorganic salt of formula (2) is preferably used as a carbonate salt in the mixing step in accordance with the present embodiment.

M⁺₂CO₃²⁻ (2)

In formula (2), M⁺ is K⁺, Rb⁺, or Cs⁺.

The inorganic salt of formula (3) is preferably used as a calcium salt in the mixing step in accordance with the present embodiment.

Ca²⁺_{(n/2)}Xⁿ⁻ (3)

In formula (3), Xⁿ⁻ is F⁻, Cl⁻, Br⁻, I⁻, NO₃⁻, or PO₄⁻. Xⁿ⁻ is preferably Cl⁻, Br⁻, I⁻, NO₃⁻, or PO₄³⁻.

At least either the aqueous solution of a carbonate salt or the aqueous solution of a calcium salt used in this step contains a quaternary ammonium salt. By mixing the aqueous solution of a carbonate salt and the aqueous solution of a calcium salt, salt is exchanged between the carbonate salt and the calcium salt. This exchange forms calcium carbonate and the above-described inorganic salt, which in turn generates the latent heat storage material containing: quaternary ammonium ions and first anions that together form a quaternary ammonium salt; metal ions and second ions that together form an inorganic salt; water; and calcium carbonate.

The method of manufacturing the latent heat storage material in accordance with the present embodiment uses liquid solutions as starting materials. The method can therefore utilize, for example, a liquid feed pump and is hence advantageous in terms of hardware and equipment. Meanwhile, a slurry solution containing poorly soluble calcium carbonate may be fed by a liquid feed pump. The method of manufacturing the latent heat storage material in accordance with the present embodiment however allows easier control of the amount of calcium carbonate charged and is less likely to cause clogging of solution feed piping than this method.

The method of manufacturing the latent heat storage material in accordance with the present embodiment forms calcium carbonate in a reaction system. The method therefore tends to promote nucleation and growth of calcium carbonate and lead to increased particle diameters, in other words, tends to lead to an increased surface area per crystal of calcium carbonate, when compared with a method of adding calcium carbonate in powder form to a solution containing the quaternary ammonium salt. Since the nucleation of a clathrate hydrate of a quaternary ammonium salt occurs on the surface of calcium carbonate as mentioned earlier, the nucleation of a clathrate hydrate of a quaternary ammonium salt will be facilitated. As a result, the latent heat storage material manufactured by the above-described manufacturing method would have a better supercooling inhibiting effect than the latent heat storage material manufactured by adding calcium carbonate in powder form to a solution containing the quaternary ammonium salt.

The present embodiment provides a latent heat storage material that retains the cold insulation capability thereof and is still restrained from supercooling. The method of manufacturing the latent heat storage material in accordance with the present embodiment enables easy manufacturing of a latent heat storage material that retains the cold insulation capability thereof and is still restrained from supercooling.

### Third Embodiment

### Cold Storage Pack

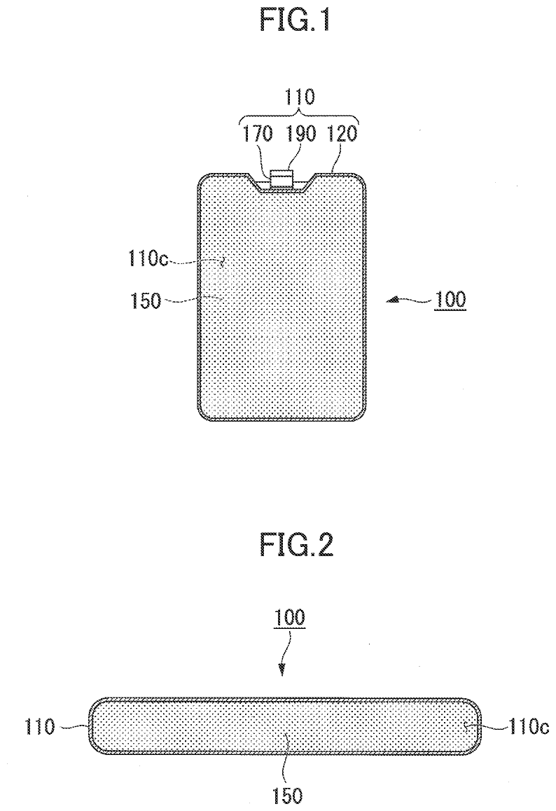

The following will describe a cold storage pack containing the aforementioned latent heat storage material with reference to FIGS. 1 and 2.

The drawings referred to in the following description may show some features out of proportion for the sake of emphasis. The relative dimensions and related factors of constituent elements may differ from their actual values for convenience. Non-feature elements may be omitted from the drawings for similar reasons.

A cold storage pack in accordance with the present embodiment maintains an object at low temperature. The object to be kept cold may be, for example, food, medicine, or the human body. Examples of such food include fresh produce such as fruit and vegetables, dairy products such as milk, processed foods such as ham, and drinks such as wine and champagne. The cold storage pack in accordance with the present embodiment may also cool a sealed space such as the inside of a refrigerator or a packaging container and an open space for air conditioning and other purposes.

Fresh produce should generally be stored in a temperature range of from 0° C., exclusive, to 15° C., inclusive. Dairy products such as milk and refrigerated foods including ham and other processed foods should generally be stored in a temperature range of from 0° C., exclusive, to 10° C., inclusive. Medicine should generally be stored in a temperature range of from 2° C. to 8° C., both inclusive.

FIG. 1 is a plan view of a cold storage pack 100 in accordance with a third embodiment. FIG. 2 is a cross-sectional view related to FIG. 1. Referring to FIGS. 1 and 2, the cold storage pack 100 includes a cold storage pack main body 110 and a latent heat storage material 150. The cold storage pack 100 in accordance with the present embodiment is of a “blow-molded type,” obtained by injecting a latent heat storage material using a cylinder pump described later in detail.

The cold storage pack main body 110 contains the latent heat storage material 150 in an internal space 110c thereof in a liquid-tight manner.

The cold storage pack main body 110 includes a housing member 120, an injection hole 170, and a sealing member 190.

The housing member 120 is hollow and preferably made of a material with high stiffness. These structural features render the housing member 120 more resistant to changes in shape when the latent heat storage material 150 changes from the solid phase to the liquid phase. Examples of such a material include resin materials such as polyethylene, polypropylene, polyester, polyurethane, polycarbonate, polyvinyl chloride, and polyamide, metals such as aluminum, stainless steel, copper, and silver, and inorganic materials such as glass and ceramics. The housing member 120 is preferably made of a resin material for durability and ease of manufacturing.

The housing member 120 may be encased in a film made primarily of polyethylene, polypropylene, polyester, polyurethane, polycarbonate, polyvinyl chloride, or polyamide. The film preferably includes a thin film of aluminum or silicon dioxide for enhanced durability and barrier properties of the film. The housing member 120 preferably has attached thereto a temperature-sensitive sticker made of a thermochromic substance so that a user can know of the temperature of the cold storage pack.

FIG. 1 shows the injection hole 170 in an upper part of the housing member 120. The latent heat storage material 150 is injected into the housing member 120 through the injection hole 170 by a method described later in detail.

The injection hole 170 is sealed by the sealing member 190.

The cold storage pack 100 in accordance with the present embodiment is capable of adjusting the temperature of an article (object to be kept cold) and/or cooling the article at a low temperature close to the onset temperature of melting of the latent heat storage material in accordance with the present embodiment when the cold storage pack 100 is placed close to or brought into contact with the article.

### Method of Manufacturing Cold Storage Pack

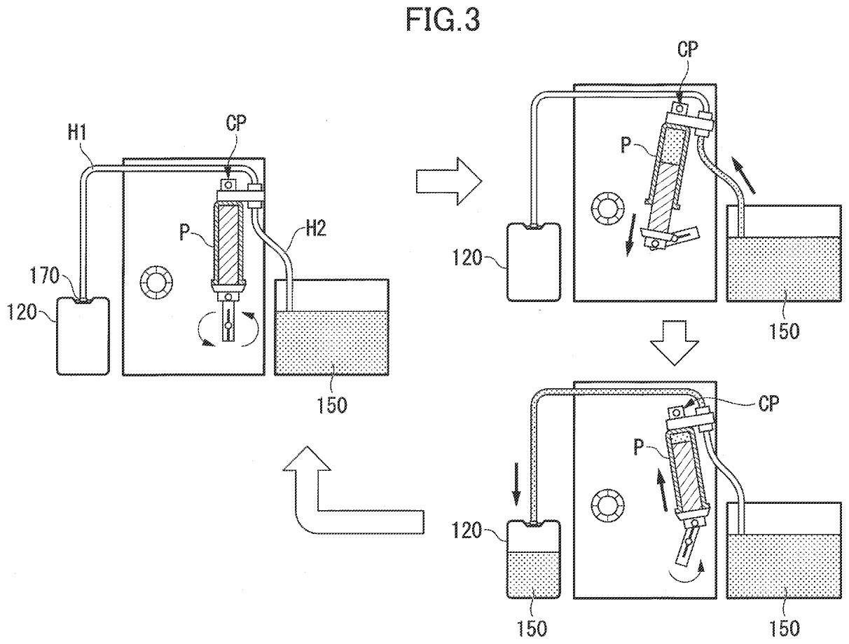

A description is now given of an exemplary method of manufacturing the cold storage pack 100 in accordance with the present embodiment. FIG. 3 is a conceptual drawing illustrating steps of manufacturing the cold storage pack 100 in accordance with the third embodiment.

Referring to FIG. 3, the latent heat storage material 150 is injected into the housing member 120 through the injection hole 170 using a cylinder pump CP. The latent heat storage material 150 is not necessarily injected by this method and may be injected using a Mohno pump.

Specifically, first, an injection hose H1 of the cylinder pump CP is attached to the injection hole 170 of the housing member 120, and a sucking hose H2 is attached to a container containing the latent heat storage material 150.

Then, a piston P of the cylinder pump CP is lowered to suck up the latent heat storage material 150. After filling the inside of the piston P with the latent heat storage material 150, the piston P is raised to inject the latent heat storage material 150 into the housing member 120.

Any volume of the latent heat storage material 150 may be injected. The latent heat storage material 150 is preferably injected up to 70% to 90% of the internal volume of the housing member 120.

The injection hole 170 is then sealed by the sealing member 190. Examples of sealing methods involving the use of the sealing member 190 include existing, hermetic sealing techniques such as ultrasonic welding and thermal welding and the use of a manually openable/closable screw plug as the sealing member 190. Ultrasonic welding, thermal welding, and other like hermetic sealing are preferred because, for example, the latent heat storage material 150 does not leak out.

Finally, the cold storage pack 100 is left to sit at a temperature lower than the solidification temperature of the latent heat storage material 150, so that the latent heat storage material 150 can solidify. The cold storage pack 100 in accordance with the present embodiment is manufactured by these steps.

The latent heat storage material 150 may be solidified before the cold storage pack 100 is placed in a logistic packaging container described later in detail as described here. Alternatively, the latent heat storage material 150 in the cold storage pack 100 may start to be used in the liquid state if it is possible to cool the logistic packaging container down to or below the onset temperature of solidification of the latent heat storage material 150 in the initial stage of a logistic process.

In an aspect, in the method of manufacturing a cold storage pack containing the latent heat storage material in accordance with the second embodiment, either the aqueous solution of a carbonate salt or the aqueous solution of a calcium salt, both described earlier, may be injected into the housing member 120 by the method illustrated in FIG. 3 before injecting the other aqueous solution. This method, since using liquid solutions, allows easier control of the amount of calcium carbonate charged and is less likely to cause clogging of the cylinder pump CP than when a slurry latent heat storage material is used. Alternatively, the aqueous solution of a carbonate salt and the aqueous solution of a calcium salt may be simultaneously injected into the housing member 120.

The latent heat storage material 150 is restrained from supercooling. The cold storage pack 100 containing the latent heat storage material 150 therefore provides sufficient cold insulation without having to spend much energy.

### Logistic Packaging Container

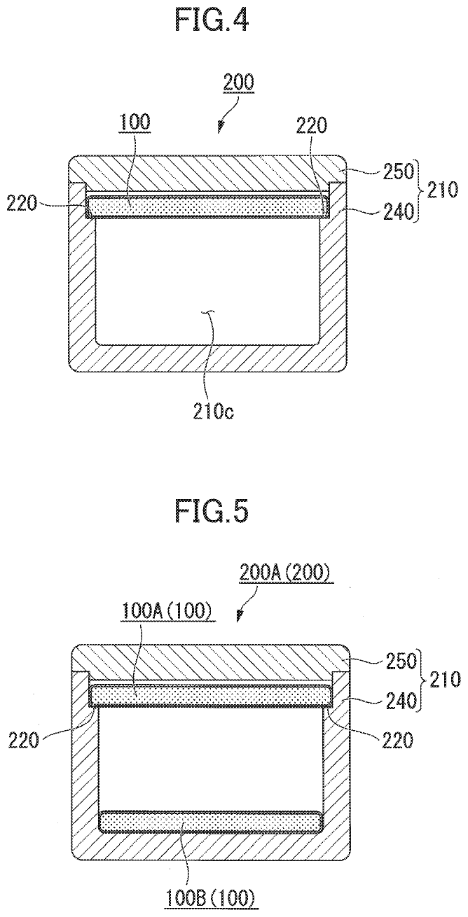

A description is now given of a logistic packaging container containing the cold storage pack 100 in accordance with the third embodiment with reference to FIG. 4.

FIG. 4 is a cross-sectional view of a logistic packaging container 200 in accordance with the third embodiment. The logistic packaging container 200 includes a logistic packaging container body 210 and the cold storage pack 100.

The logistic packaging container body 210 is of such a size that one can carry around and includes a wall section 240 and a lid section 250.

The wall section 240 has an opening through which the cold storage pack 100 and articles can be put into, and taken out of, the logistic packaging container 200. The wall section 240 includes a cold-storage-pack-holding section 220 for holding the cold storage pack 100. The cold-storage-pack-holding section 220 is formed by cutting out the upper ends of the wall section 240 constituting the side surfaces of the logistic packaging container body 210. The cold-storage-pack-holding section 220 is provided on the opposing upper ends of the wall section 240. The cold-storage-pack-holding section may be provided on the upper ends of the wall section 240 all around the wall section 240.

The cold-storage-pack-holding section 220 is disposed in the logistic packaging container body 210. The cold storage pack 100 is placed in the cold-storage-pack-holding section 220 when the logistic packaging container 200 is used. This structure maintains the inside of the logistic packaging container body 210 at a temperature close to the melting point of the latent heat storage material in the cold storage pack 100. The cold-storage-pack-holding section 220 may be structured such that the cold storage pack 100 can be secured in place.

The wall section 240 is preferably made of a thermally insulating material such as styrene foam, urethane foam, or a vacuum insulation material. Alternatively, the wall section 240 may include: a main body made of a material that may or may not be thermally insulating; and a thermal insulation layer of a thermally insulating material disposed inside or outside the main body.

The lid section 250 closes the opening of the wall section 240. The lid section 250 is made of one of the materials listed as materials for the wall section 240. The lid section 250 may be made of the same material as the wall section 240 and may be made of a different material from the wall section 240.

The wall section 240 and the lid section 250 may be either coupled or separated. The lid section 250 is preferably structured so as to tightly seal the wall section 240 in order to restrict the flow of heat into and out of the logistic packaging container 200.

The logistic packaging container body 210 has an internal space 210c for housing an article. The internal space 210c is surrounded by the wall section 240 and the lid section 250.

Articles, being placed in the internal space 210c of the logistic packaging container body 210, are maintained near the melting point of the latent heat storage material.

### Variation Examples

FIG. 5 is a cross-sectional view of a logistic packaging container (variation example) 200A in accordance with the third embodiment. Referring to FIG. 5, the logistic packaging container 200A includes two cold storage packs 100. The two cold storage packs 100 are disposed opposite each other in the logistic packaging container 200A. One of the cold storage packs (cold storage pack 100A) is held by the cold-storage-pack-holding section 220. Portions of the wall section 240 serve as the holding member recited in patent claims in the logistic packaging container 200A. The other one of the cold storage packs (cold storage pack 100B) is disposed on the internal bottom surface of the logistic packaging container body 210. This structure restricts heat flow from a bottom surface 210a to an object X to be kept cold.

The cold storage pack 100 does not change much in shape when the latent heat storage material changes from the solid phase to the liquid phase. The logistic packaging container 200A can hence house the object X therein in a stable manner.

Heat is transferred from substance to substance by one of three manners: convection, conduction, and radiation. Conduction, among them, would result in the least heat loss.

With the cold storage pack 100B being disposed in the location described here, the logistic packaging container 200A allows the object X and the cold storage pack 100B to be in contact with each other inside the logistic packaging container body 210. By bringing the object X into contact with the cold storage pack 100B, heat conducts between the object X and the cold storage pack 100B, which will cool the object X. This mechanism is not easily affected by the heat flow from the outside to the logistic packaging container 200A.

On the other hand, when the cold storage pack 100 and the object X are separated as in the logistic packaging container 200 illustrated in FIG. 4, there occurs heat convection between the cold storage pack 100 and the object X, which will cool the object X. This mechanism is easily affected by the heat flow from the outside to the logistic packaging container 200A and is unlikely to be capable of cooling at a temperature very close to the melting point of the latent heat storage material.

The logistic packaging container 200A is therefore less affected by an incoming heat flow than the logistic packaging container 200 and can hence better control the temperature of the object X at a temperature close to the melting point of the latent heat storage material.

The cold storage pack 100A and the cold storage pack 100B may be made of the same latent heat storage material and may be made of different latent heat storage materials. Specifically, the cold storage pack 100A may be made of a latent heat storage material in accordance with the first embodiment, and the cold storage pack 100B may be made of a latent heat storage material in accordance with the second embodiment.

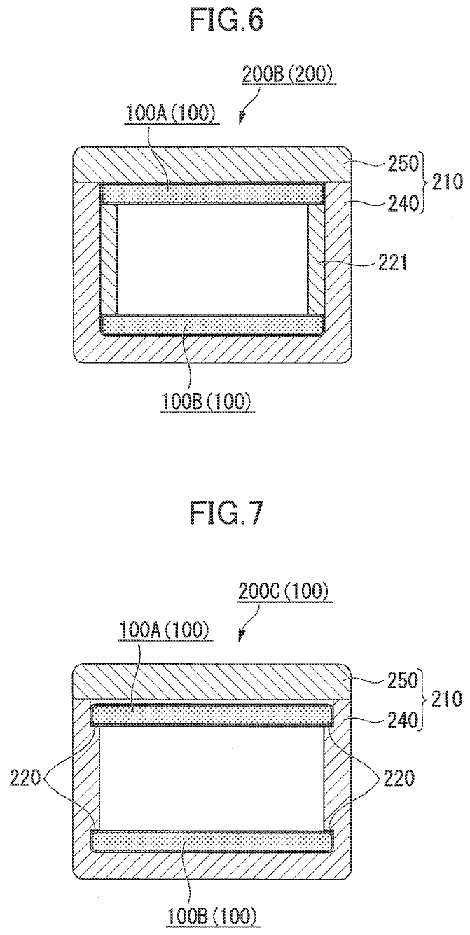

FIG. 6 is a cross-sectional view of a logistic packaging container (variation example) 200B in accordance with the third embodiment. The logistic packaging container 200B differs from the logistic packaging container 200A illustrated in FIG. 5 in that the former includes a cold-storage-pack-holding member 221 on the internal side surfaces of the logistic packaging container body 210. One of the cold storage packs (cold storage pack 100A) is held by the cold-storage-pack-holding member 221. The other one of the cold storage packs (cold storage pack 100B) is disposed on the internal bottom surface of the logistic packaging container body 210.

The logistic packaging container 200B can better control the temperature of the object to be kept cold than the logistic packaging container 200, similarly to the logistic packaging container 200A illustrated in FIG. 5.

The logistic packaging container body may, in an aspect of the present invention, have large dimensions like, for example, a shipping container. In another aspect of the present invention, the logistic packaging container may include a cooling device like a reefer container.

FIG. 7 is a cross-sectional view of a logistic packaging container (variation example) 200C in accordance with the third embodiment. The logistic packaging container 200 differs from the logistic packaging container 200A illustrated in FIG. 5 in that the former includes a cold-storage-pack-holding section 220 formed by cutting out the upper ends and the lower ends of the wall section constituting the side surfaces of the logistic packaging container body. This structure securely fixes the two cold storage packs 100 in place when the logistic packaging container 200C in accordance with the present embodiment is used in an inclined posture.

The logistic packaging container 200C can better control the temperature of the object to be kept cold than the logistic packaging container 200, similarly to the logistic packaging container 200A illustrated in FIG. 5.

The logistic packaging container may, in an aspect of the present invention, include any number of cold storage packs and may include three or more cold storage packs.

The logistic packaging container may, in an aspect of the present invention, include cold storage packs built into the logistic packaging container body. Alternatively, the cold storage pack itself may serve as a logistic packaging container.

The logistic packaging container may, in an aspect of the present invention, include a lid section that in turn includes a holder-holding member.

The logistic packaging container 200 in accordance with the third embodiment, including the cold storage pack 100, provides sufficient cold insulation without having to spend much energy.

### Fourth Embodiment

### Cold Storage Pack

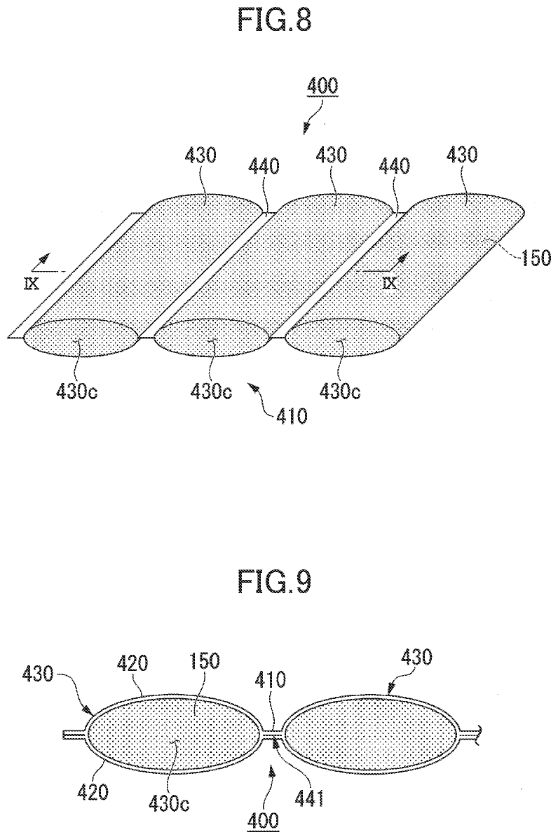

The following will describe a cold storage pack containing the aforementioned latent heat storage material with reference to FIGS. 8 and 9.

FIG. 8 is a perspective view of a cold storage pack 400 in accordance with a fourth embodiment. FIG. 9 is a cross-sectional view taken along line IX-IX shown in FIG. 8. Referring to FIGS. 8 and 9, the cold storage pack 400 in accordance with the present embodiment includes a latent heat storage material 150 and a cold storage pack main body 410. The cold storage pack 400 is of a “film-packed” type. Accordingly, members of the present embodiment that are the same as those in the third embodiment are indicated by the same reference signs or numerals, and detailed description thereof is omitted.

The cold storage pack main body 410 includes a plurality of encasing sections 430 and a plurality of articulation sections 440.

Each encasing section 430 contains the latent heat storage material 150 in an internal space 430c thereof in a liquid-tight manner.

The encasing sections 430 are shaped like strips. The encasing sections 430 have an elliptic cross-section in FIG. 9, but may have a different cross-sectional shape.

FIGS. 8 and 9 show three encasing sections 430. The cold storage pack main body 410 may alternatively include a different number of encasing sections 430. The cold storage pack 400 can be changed in size by changing the number of encasing sections 430 in accordance with the size of the object to be kept cold.

Each articulation section 440 connects two encasing sections 430 with each other and has articulation capability. The cold storage pack 400, including the articulation sections 440, is capable of coming into contact with the object to be kept cold by changing shape in accordance with the shape of the object even when the latent heat storage material 150 is in the solid state. The cold storage pack 400 can hence cool the object efficiently even when the object has a complex shape.

Referring to FIG. 9, the cold storage pack main body 410 includes film members 420. The film members 420 are joined by a plurality of attaching sections 441. Those portions of the film members 420 which overlap the attaching sections 441 in a plan view function as the articulation sections 440. The portions of the film members 420 other than those portions which overlap the attaching sections 441 in a plan view function as the encasing sections 430.

The film members 420 are preferably made of a material capable of restraining the latent heat storage material 150 from leaking out and volatilizing. The film members 420 are preferably made of a material capable of joining the film members 420 together in the manufacturing process that will be described later in detail. Additionally, the film members 420 are preferably made of a flexible material that can impart an articulation capability to the articulation sections 440.

From these points of view, the film members 420 are preferably made of, for example, polyethylene, polypropylene, polyamide, or polyester. The film members 420 may be made of a single source material or a combination of two or more source materials. Each film member 420 may include a single layer or a plurality of layers.

The film member 420 preferably includes a multilayer film that in turn includes a low-density polyethylene resin layer and a polyamide resin layer. In such cases, the articulation section 440 can be prepared by stacking two multilayer films on top of each other in such a manner that the low-density polyethylene resin layers therein face each other and then firmly attaching the contact surfaces of the low-density polyethylene resin layers together by thermocompression.

The film member 420 preferably includes a thin film of aluminum or silicon dioxide for enhanced durability and barrier properties. The film member 420 preferably has attached thereto a temperature-sensitive sticker made of a thermochromic substance so that a user can know of the temperature of the cold storage pack 400.

The film member 420 may have the exterior thereof further packaged with another film (“pack-in-pack structure”) for improvement of the physical strength, texture, and thermal insulation properties of the cold storage pack 400.

The cold storage pack 400 may be attached to a jig capable of securing the cold storage pack 400 to an object to be kept cold, so that the cold storage pack 400 can be secured to the object when used. The jig may be, for example, an elastic band, a towel, or a bandage.

The cold storage pack 400 in accordance with the fourth embodiment provides sufficient cold insulation without having to spend much energy similarly to the cold storage pack 100 in accordance with the third embodiment.

### Method of Manufacturing Cold Storage Pack

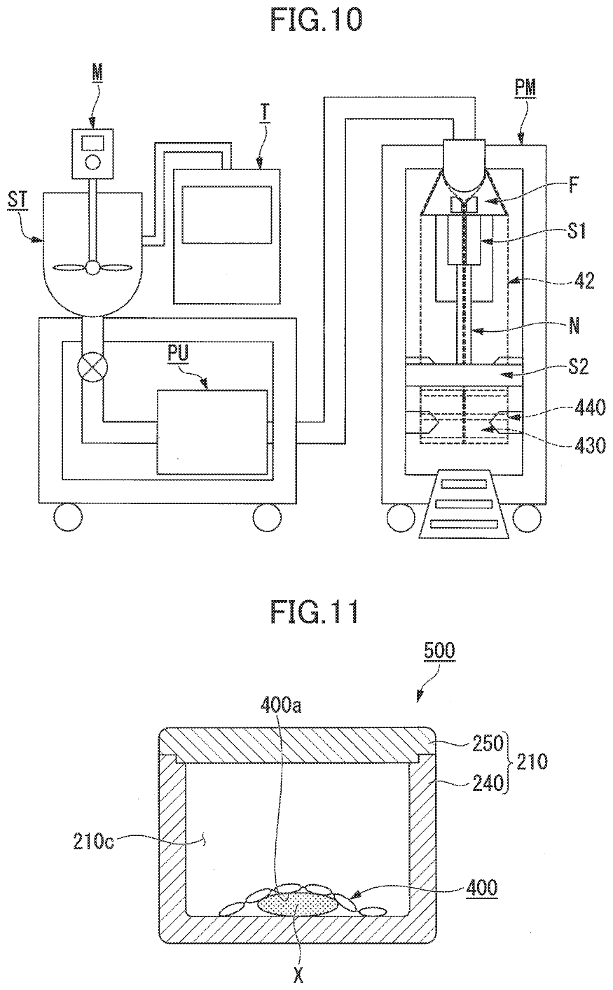

A description is now given of an exemplary method of manufacturing the cold storage pack 400 in accordance with the present embodiment. FIG. 10 is a schematic diagram of a structure of apparatus used in manufacturing the cold storage pack 400 in accordance with the fourth embodiment. FIG. 10 shows a “vertical form-fill seal machine,” which is a manufacturing machine used in food packaging.

The latent heat storage material 150 retained in a thermostatic tank T is first transported to a stirring tank ST where the latent heat storage material 150 is stirred using a stirrer M. Next, a film (not shown) is fed from a roll, and a film 42 has the lengthwise ends thereof aligned to each other in a former unit F in a packaging machine PM. The lengthwise ends are then securely joined together by thermocompression in a vertical sealing unit S1 to form a tube of film. The film 42, now tubular, has the widthwise ends thereof closed by thermocompression in a horizontal sealing unit S2. Next, a pump PU is turned on to inject the latent heat storage material 150 into the tubular film 42 through a nozzle N. Thereafter, the tubular film 42 has widthwise parts thereof closed by thermocompression in the horizontal sealing unit S2, to form the articulation sections 440 and the encasing sections 430, which concludes the manufacture of the cold storage pack 400.

In an aspect, in the method of manufacturing a cold storage pack containing the latent heat storage material in accordance with the second embodiment, either the aqueous solution of a carbonate salt or the aqueous solution of a calcium salt, both described earlier, may be injected into the tubular film 42 by the method illustrated in FIG. 10 before injecting the other aqueous solution. This method, since using liquid solutions, allows easier control of the amount of calcium carbonate charged and is less likely to cause clogging of the pump PU than when a slurry latent heat storage material is used. Alternatively, the aqueous solution of a carbonate salt and the aqueous solution of a calcium salt may be simultaneously injected into the tubular film 42.

### Logistic Packaging Container

A description is now given of a logistic packaging container containing the cold storage pack 400 in accordance with the fourth embodiment with reference to FIG. 11.

FIG. 11 is a cross-sectional view of a logistic packaging container 500 in accordance with the fourth embodiment. Referring to FIG. 11, the logistic packaging container 500 includes the logistic packaging container body 210 and the cold storage pack 400. Accordingly, members of the present embodiment that are the same as those in the third embodiment are indicated by the same reference signs or numerals, and detailed description thereof is omitted.

In the logistic packaging container 500, the cold storage pack 400 covers an object X to be kept cold from above. This arrangement enables at least a part of the cold storage pack 400 to be in contact with the object X in the logistic packaging container body 210 of the logistic packaging container 500. Thus, heat conducts through a contact surface 400a between the object X and the cold storage pack 400, which will cool the object X. This mechanism is not easily affected by the heat flow from the outside to the logistic packaging container 500. The logistic packaging container 500 is therefore capable of efficiently cooling the object X.

On the other hand, when the object is cooled with the object being separated by a distance from the cold storage pack as in the logistic packaging container 200 in accordance with the third embodiment (see FIG. 4), there occurs heat exchange with the air in the internal space of the logistic packaging container body, which in turn renders the refrigeration temperature of the object higher than the onset temperature of melting of the latent heat storage material in the cold storage pack. The latent heat storage material therefore needs to have an onset temperature of melting lower than the lower limit of the temperature range in which the object should be kept. If the cold storage pack 400 contains such a latent heat storage material, however, the temperature of the object may decrease below the lower limit of the temperature range in which the object should be kept.

In contrast, the logistic packaging container 500 in accordance with the present embodiment is capable of cooling the object X at a temperature close to the onset temperature of melting of the latent heat storage material in the cold storage pack 400. The logistic packaging container 500 is hence suited to the cooling and transport of medicine, which requires rigorous temperature control, and the cooling and transport of fresh produce, which may easily suffer from low-temperature damage.

The logistic packaging container 500 may include a thermal insulation member above the cold storage pack 400 for enhanced cold insulation of the object X.

The cold storage pack 400 may be changed in a suitable manner, for example, in shape, number, and/or posture during use in accordance with the shape and properties of the object X.

### Variation Examples

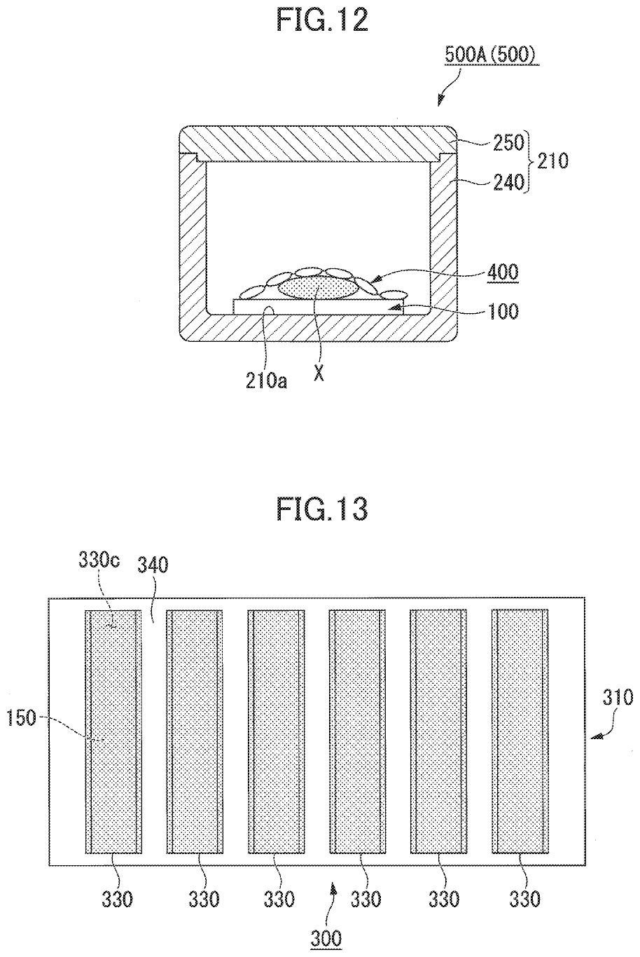

FIG. 12 is a cross-sectional view of a logistic packaging container (variation example) 500A in accordance with the third embodiment. The logistic packaging container 500A differs from the logistic packaging container 500 illustrated in FIG. 11 in that the former includes the cold storage pack 100 in accordance with the third embodiment (see FIGS. 1 and 2) in addition to the cold storage pack 400. In the logistic packaging container 500A, the cold storage pack 100 is disposed between the object X and an internal bottom surface 210a of the logistic packaging container body 210. This structure can restrain the heat flow from the bottom surface 210a to the object X.

The cold storage pack 100 does not change much in shape when the latent heat storage material changes from the solid phase to the liquid phase as described earlier. The logistic packaging container 500A can hence house the object X therein in a stable manner.

The logistic packaging container 500 in accordance with the fourth embodiment, including the cold storage pack 400, provides sufficient cold insulation without having to spend much energy.

### Fifth Embodiment

### Cold Storage Pack

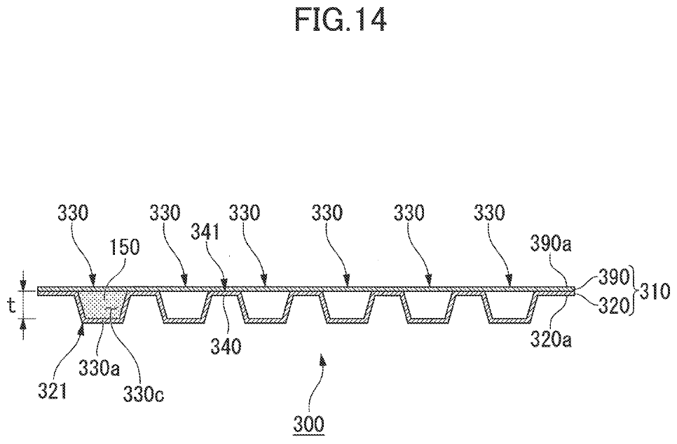

The following will describe a cold storage pack containing the aforementioned latent heat storage material with reference to FIGS. 13 and 14.

FIG. 13 is a plan view of a cold storage pack 300 in accordance with a fifth embodiment. FIG. 14 is a cross-sectional view related to FIG. 13. Referring to FIGS. 13 and 14, the cold storage pack 300 in accordance with the present embodiment includes a latent heat storage material 150 and a cold storage pack main body 310. The cold storage pack 300 is of a “blister pack” type. Accordingly, members of the present embodiment that are the same as those in the third embodiment are indicated by the same reference signs or numerals, and detailed description thereof is omitted.

The cold storage pack main body 310 includes a plurality of encasing sections 330 and a plurality of articulation sections 340.

A housing member 320 contains the latent heat storage material 150 in an internal space 330c thereof in a liquid-tight manner.

The housing member 320 is shaped like strips. The encasing sections 330 have a trapezoidal cross-section in FIG. 14, but may have a different cross-sectional shape.

FIGS. 13 and 14 show six encasing sections 330. The cold storage pack main body 310 may alternatively include a different number of encasing sections 330. The cold storage pack 300 can be changed in size by changing the number of encasing sections 330 in accordance with the size of the object to be kept cold.

The latent heat storage material 150 in the encasing sections 330 may be of a single type and may be a combination of two or more types with different onset temperatures of melting. The use of such a cold storage pack 300 enables simultaneous cooling of a plurality of objects that have different storage temperatures.

Each encasing sections 330 has a contact surface 330a that may be concave in order to increase the contact area thereof with drink cans. Additionally, the encasing section 330 may be changed in the thickness t thereof along the length thereof such that the cold storage pack 300 can fit, for example, a wine bottle.

Each articulation section 340 connects two encasing sections 330 with each other and has articulation capability. The cold storage pack 300, including the articulation sections 340, is capable of coming into contact with the object to be kept cold by changing shape in accordance with the shape of the object even when the latent heat storage material 150 is in the solid state. The cold storage pack 300 can hence cool the object efficiently even when the object has a complex shape.

Referring to FIG. 14, the cold storage pack main body 310 includes the housing member 320 and a sealing member 390. The housing member 320 and the sealing member 390 are joined by a plurality of attaching sections 341. Those portions of the housing member 320 and the sealing member 390 which overlap the attaching sections 341 in a plan view function as the articulation sections 340. The portions of the housing member 320 and the sealing member 390 other than those portions which overlap the attaching sections 341 in a plan view function as the encasing sections 330.

The housing member 320 includes a plurality of concave sections 321. The concave sections 321 and a sealing member 190 form the encasing sections 330. The housing member 320 is preferably made of a material that has sufficient hardness to preserve the shape of the concave sections 321.

The sealing member 390 is planar.

The housing member 320 and the sealing member 390 are preferably made of a material capable of restraining the latent heat storage material 150 from leaking out and volatilizing. The housing member 320 and the sealing member 390 are preferably made of a flexible material that can impart an articulation capability to the articulation sections 340. Additionally, the housing member 320 and the sealing member 390 are preferably made of a material capable of being joined together in the manufacturing process that will be described later in detail.

The housing member 320 is preferably made of, for example, polyethylene, polypropylene, polyamide, polyester, polycarbonate, or polyvinyl chloride. The housing member 320 preferably has a thickness of, for example, from 100 μm to 1000 μm, both inclusive. When the housing member 320 has a thickness in this range, the housing member 320 is sufficiently flexible to impart an articulation capability to the articulation sections 340.

The sealing member 390 is preferably made of, for example, polyethylene, polypropylene, polyamide, or polyester. The sealing member 390 preferably has a thickness of from 50 μm to 100 μm, both inclusive. When the sealing member 390 has a thickness in this range, the sealing member 390 is sufficiently flexible to impart an articulation capability to the articulation sections 340.

The housing member 320 and the sealing member 390 may be made of a single source material or a combination of two or more source materials. The housing member 320 and the sealing member 390 may each include a single layer or a plurality of layers.

The housing member 320 and the sealing member 390 preferably each include a multilayer film that in turn includes a linear, low-density polyethylene resin layer and a polyamide resin layer. In such cases, the articulation section 340 can be prepared by stacking two multilayer films on top of each other in such a manner that the low-density polyethylene resin layers therein face each other and then firmly attaching the contact surfaces of the low-density polyethylene resin layers together by thermocompression.

Either one or both of the housing member 320 and a sealing member 290 preferably include(s) a thin film of aluminum or silicon dioxide for enhanced durability and barrier properties. Either one or both of the housing member 320 and the sealing member 390 preferably has (have) attached thereto a temperature-sensitive sticker made of a thermochromic substance so that a user can know of the temperature of the cold storage pack 300.

The housing member 320 and the sealing member 390 may include a fixing section. With the fixing section being provided, the cold storage pack 300 can be placed around the object to be kept cold in such a manner as to enclose the object. The fixing section may be, for example, a hook and loop fastener composed of a surface 320a of the housing member 320 and a surface 390a of the sealing member 390.

### Variation Examples

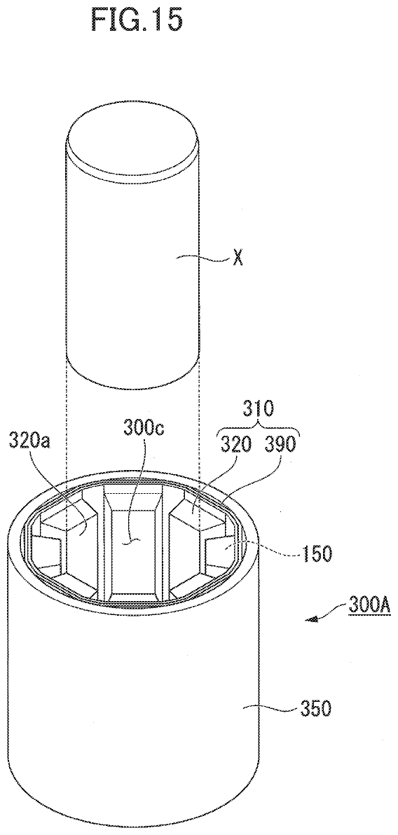

FIG. 15 is a perspective view of a cold storage pack (variation example) 300A in accordance with the fifth embodiment. The cold storage pack 300A differs from the cold storage pack 300 illustrated in FIGS. 13 and 14 in that the former includes a cold-storage-pack holder 350.

The cold-storage-pack holder 350 is generally cylindrical and has an open end. The cold-storage-pack holder 350 has therein a space to accommodate the latent heat storage material 150 and the cold storage pack main body 310. The cold storage pack main body 310 is deformed generally to the shape of a cylinder, so that the housing member 320 faces inside and the sealing member 390 faces outside. The cold storage pack 300, including the cold-storage-pack holder 350, has a generally cylindrical shape itself and for this reason can stand alone.

The cold-storage-pack holder 350 is preferably made of a thermally insulating material that can restrict heat exchange with the open air. Examples of such a material include polyethylene foam, urethane foam, and chloroprene rubber (rubber foam).

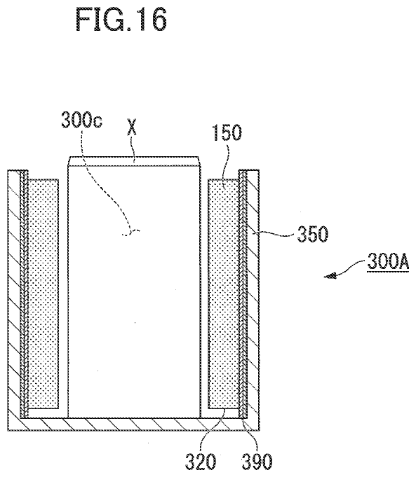

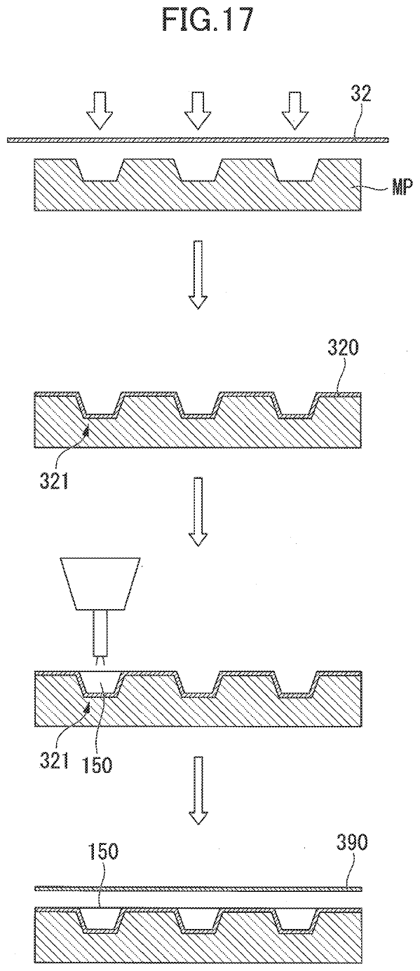

FIG. 16 is a conceptual drawing showing how to use the cold storage pack 300A in accordance with the fifth embodiment. Referring to FIG. 16, an object X to be kept cold, for example, a drink can or a drink bottle, can be cooled using the cold storage pack 300A in accordance with the fifth embodiment, by placing the object X in a generally cylindrical space 300c in the cold storage pack 300A, so that the object X is placed near or in contact with the cold storage pack 300A. The object X can be hence maintained at a temperature close to the onset temperature of melting of the latent heat storage material 150 in the cold storage pack 300A.

In such cases, the cold-storage-pack holder 350 is preferably at least partially made of an elastic material in order to allow the object X to assume a range of diameters. The elastic force exerted by the cold-storage-pack holder 350 brings the object X into contact with the cold storage pack 300A.

### Method of Manufacturing Cold Storage Pack

A description is now given of an exemplary method of manufacturing the cold storage pack 300 in accordance with the present embodiment. FIG. 17 is a conceptual drawing illustrating steps of manufacturing the cold storage pack 300 in accordance with the fifth embodiment. FIGS. 14 and 17 show different numbers of encasing sections 330.

First, a hard film 32, which is a starting material for the housing member 320, is placed in a metal mold MP that has grooves with a trapezoidal cross-section. The hard film 32 is then vacuum-molded or pressed into the housing member 320. Next, a volume of the latent heat storage material 150 in the liquid state is injected into the concave sections 321 of the housing member 320 using, for example, a pump. The sealing member 390 is then placed on the housing member 320, and the contact surfaces of the housing member 320 and the sealing member 390 are firmly attached together by thermocompression, to form the encasing sections 330 and the articulation sections 340.

In an aspect, in the method of manufacturing a cold storage pack containing the latent heat storage material in accordance with the second embodiment, either the aqueous solution of a carbonate salt or the aqueous solution of a calcium salt, both described earlier, may be injected into the concave sections 321 of the housing member 320 by the method illustrated in FIG. 17 before injecting the other aqueous solution. This method, since using liquid solutions, allows easier control of the amount of calcium carbonate charged and is less likely to cause clogging of the pump or other like device used in the injection of the liquid solutions than when a slurry latent heat storage material is used. Alternatively, the aqueous solution of a carbonate salt and the aqueous solution of a calcium salt may be simultaneously injected into the concave sections 321 of the housing member 320.

### Logistic Packaging Container

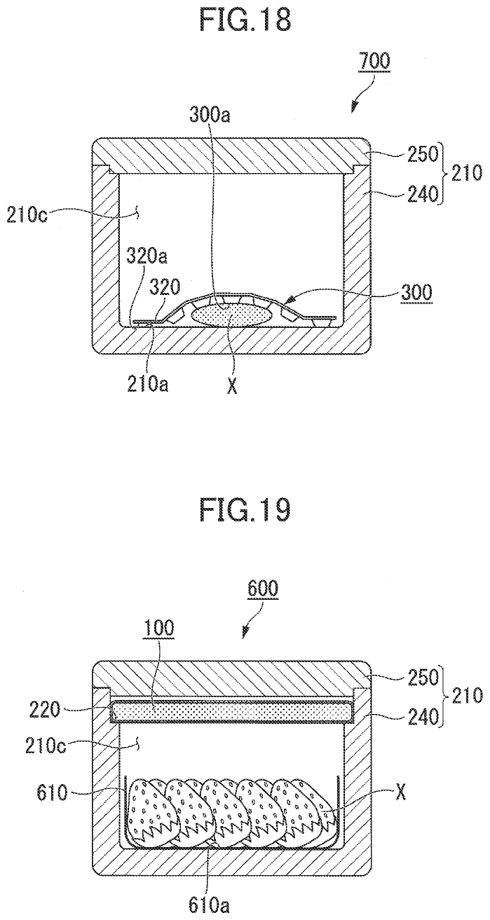

A description is now given of a logistic packaging container containing the cold storage pack 300 in accordance with the fifth embodiment with reference to FIG. 18.

FIG. 18 is a cross-sectional view of a logistic packaging container 700 in accordance with the fifth embodiment. The logistic packaging container 700 includes a logistic packaging container body 210 and the cold storage pack 300. Accordingly, members of the present embodiment that are the same as those in the third embodiment are indicated by the same reference signs or numerals, and detailed description thereof is omitted.

In the logistic packaging container 700, the cold storage pack 300 covers an object X to be kept cold from above. This arrangement enables at least a part of the cold storage pack 300 to be in contact with the object X in the logistic packaging container body 210 of the logistic packaging container 700. Thus, heat conducts through a contact surface 300a between the object X and the cold storage pack 300, which will cool the object X. This mechanism is not easily affected by the heat flow from the outside to the logistic packaging container 700. The logistic packaging container 700 is therefore capable of efficiently cooling the object X.

The logistic packaging container 70 in accordance with the present embodiment is capable of cooling the object X at a temperature close to the onset temperature of melting of the latent heat storage material in the cold storage pack 300. The logistic packaging container 700 is hence suited to the cooling and transport of medicine, which requires rigorous temperature control, and the cooling and transport of fresh produce, which may easily suffer from low-temperature damage.

The logistic packaging container 700 in accordance with the present embodiment may include, for example, a hook and loop fastener that fixes the surface 320a of the housing member 320 and the bottom surface 210a of the logistic packaging container body 210 to each other.

The logistic packaging container 700 may include a thermal insulation member above the cold storage pack 300 for enhanced cold insulation of the object X.

The logistic packaging container 700 in accordance with the fifth embodiment, including the cold storage pack 300, provides sufficient cold insulation without having to spend much energy.

### Sixth Embodiment

### Food Cooling Tool

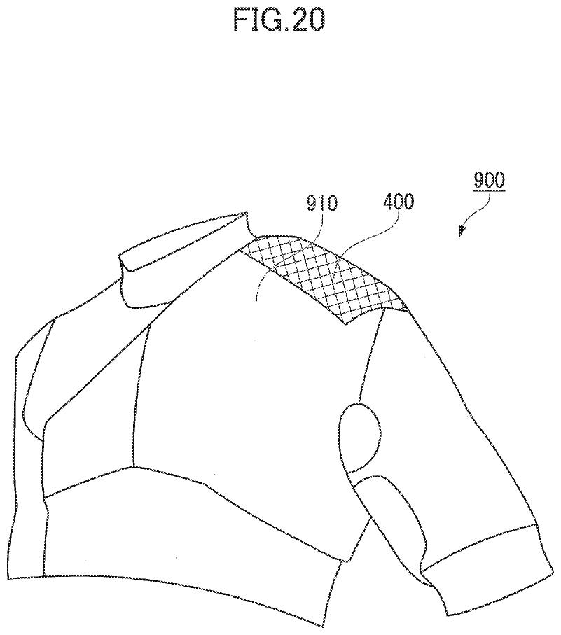

The following will describe a food cooling tool containing the aforementioned latent heat storage material with reference to FIG. 19.

FIG. 19 is a conceptual drawing showing how to use a food cooling tool 600 in accordance with a sixth embodiment. The food cooling tool 600 includes a logistic packaging container body 210, a cold storage pack 100, and an internal container 610. Accordingly, members of the present embodiment that are the same as those in the third embodiment are indicated by the same reference signs or numerals, and detailed description thereof is omitted.

The internal container 610 holds food therein. Owing to the provision of the internal container 610, the food cooling tool 600 can limit direct contact between fresh foods such as meat and fish and fresh produce such as vegetables and fruit in the logistic packaging container body 210. This structure can reduce, for example, cross-contamination caused by food poisoning bacteria. The internal container 610 preferably has a surface 610a thereof coated with, for example, an antibacterial agent.

The food cooling tool 600 in accordance with the sixth embodiment, including the cold storage pack 100, provides sufficient cold insulation without having to spend much energy.

### Seventh Embodiment

### Human Body Cooling Tool

The following will describe a human body cooling tool containing the aforementioned latent heat storage material with reference to FIG. 20.

FIG. 20 is a conceptual drawing showing how to use a human body cooling tool 900 in accordance with a seventh embodiment. The human body cooling tool 900 includes a cold storage pack 400 and a jig 910. Accordingly, members of the present embodiment that are the same as those in the fourth embodiment are indicated by the same reference signs or numerals, and detailed description thereof is omitted.

The jig 910 secures the cold storage pack 400 onto the human body. The jig 910 may be an elastic band, a towel, or a bandage. The jig 910 and the cold storage pack 400 may be integrated into a single piece and may be individually provided.

The human body cooling tool 900 in accordance with the seventh embodiment, including the cold storage pack 400, provides sufficient cold insulation without having to spend much energy.

### Eighth Embodiment

### Refrigerator

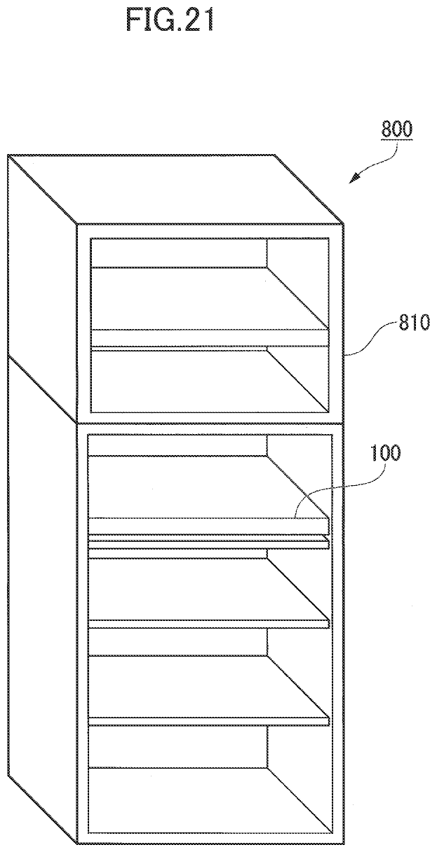

The following will describe a refrigerator containing the aforementioned latent heat storage material with reference to FIG. 21.

FIG. 21 is a cross-sectional view of a refrigerator 800 in accordance with an eighth embodiment. Doors are omitted in FIG. 21. Referring to FIG. 21, the refrigerator 800 includes a cold storage pack 100 and a refrigerator main body 810. Accordingly, members of the present embodiment that are the same as those in the third embodiment are indicated by the same reference signs or numerals, and detailed description thereof is omitted.

The refrigerator main body 810 has a sufficient internal space to store, for example, food or medicine. The cold storage pack 100 is disposed in the internal space of the refrigerator main body 810. This structure enables the cold storage of, for example, food and medicine even when electric power supply to the refrigerator 800 is disrupted.

The refrigerator 800 in accordance with the eighth embodiment, including the cold storage pack 100, provides sufficient cold insulation without having to spend much energy.

Preferred embodiments of the present invention have been so far described in reference to the attached drawings. The present invention is by no means limited to the embodiments and examples described above. The shapes, combinations, and other specifics of the members described in the foregoing examples are mere examples and may be altered in various manners in accordance with design requirements and other conditions, without departing from the scope of the present invention.

For instance, the logistic packaging container 200 in accordance with the third embodiment may be used in combination with the cold storage pack 300 in accordance with the fifth embodiment or the cold storage pack 400 in accordance with the fourth embodiment.

The food cooling tool 600 in accordance with the sixth embodiment may include the cold storage pack 300 in accordance with the fifth embodiment or the cold storage pack 400 in accordance with the fourth embodiment as a cold storage pack.

The human body cooling tool 900 in accordance with the seventh embodiment may include the cold storage pack 100 in accordance with the third embodiment or the cold storage pack 300 in accordance with the fifth embodiment as a cold storage pack.

The refrigerator 800 in accordance with the eighth embodiment may include the cold storage pack 300 in accordance with the fifth embodiment or the cold storage pack 400 in accordance with the fourth embodiment as a cold storage pack.

The cold storage pack 400 in accordance with the fourth embodiment may include a cold-storage-pack holder.

### EXAMPLES

The following will describe the present invention by way of examples. The present invention is not limited by these examples.

### Evaluation of Solidification Behavior of Latent Heat Storage Material

Approximately 50 grams of the latent heat storage material was first weighed out and poured into a glass tube bottle. Temperature was measured at the center of the latent heat storage material in the glass tube bottle using a thermocouple. The glass tube bottle was placed in a thermostatic tank equipped with a temperature-varying function at room temperature. Next, the latent heat storage material was cooled under Conditions 1 to 4 below to solidify the latent heat storage material. Graphs representing the solidification behavior of the latent heat storage material with respect to cooling time were hence obtained with the start of the cooling being plotted at zero hours.

Condition 1: the internal temperature of the thermostatic tank was lowered from 30° C. to −30° C. at a cooling rate of 0.25° C./minute.

Condition 2: the internal temperature of the thermostatic tank was lowered stepwise to 5° C., 2.5° C., 0° C., and then −2.5° C. in every 10 hours.

Condition 3: the internal temperature of the thermostatic tank was maintained at 5° C. for 17 hours.

Condition 4: the internal temperature of the thermostatic tank was maintained at 3° C. for 17 hours.

The temperature of the latent heat storage material was differentiated with respect to cooling time on the obtained solidification behavior graphs. The temperature T (° C.) of the latent heat storage material at the time when the differential value became equal to zero for the first time was compared.

### Measurement of Onset Temperature of Melting of Latent Heat Storage Material

The value obtained by differential scanning calorimetry (DSC) was used as the onset temperature of melting of the latent heat storage material. Specifically, the latent heat storage material in the liquid state (approximately 4 milligrams) was first enclosed in an aluminum pan prepared for DSC measurement. The enclosed latent heat storage material was cooled at a rate of 5° C./minute to change from the liquid state to the solid state, and then heated at a rate of 5° C./minute. An endothermic peak appeared on the DSC curve when the latent heat storage material changed from the solid state to the liquid state in the heating. The onset temperature of melting was obtained as the intersection of the extrapolation of the rising portion of the endothermic peak and the extrapolation of the baseline of the endothermic peak.

### Measurement of Amount of Latent Heat of Latent Heat Storage Material

The value obtained by dividing, by the mass of the sample, the area of the endothermic peak obtained in “Measurement of Onset Temperature of Melting of Latent Heat Storage Material” above was taken as the amount of latent heat per unit mass.

### Evaluation of Restrained Supercooling in Latent Heat Storage Material

### Example 1-1

TBAB was used as a quaternary ammonium salt. TBAB was put into water in a container in the ratio shown in Table 1. The mixture was stirred at 600 rpm for 1 hour using a mechanical stirrer to completely dissolve the TBAB, thereby preparing an aqueous solution. Calcium carbonate was added to this aqueous solution in the ratio shown in Table 1 to obtain a latent heat storage material of Example 1.

### Example 1-2

TBAB and potassium bromide were used as a quaternary ammonium salt and an inorganic salt respectively. TBAB and potassium bromide were put into water in this order in the ratio shown in Table 1. The mixture was stirred at 600 rpm for 1 hour using a mechanical stirrer to completely dissolve the TBAB and potassium bromide, thereby preparing an aqueous solution. Calcium carbonate was added to this aqueous solution in the ratio shown in Table 1 to obtain a latent heat storage material of Example 1-2.

### Example 1-3

TBAB and potassium nitrate were used as a quaternary ammonium salt and an inorganic salt respectively. TBAB and potassium nitrate were put into water in this order in the ratio shown in Table 1. The mixture was stirred at 600 rpm for 1 hour using a mechanical stirrer to completely dissolve the TBAB and potassium nitrate, thereby preparing an aqueous solution. Calcium carbonate was added to this aqueous solution in the ratio shown in Table 1 to obtain a latent heat storage material of Example 1-3.

### Example 1-4

TBAC was used as a quaternary ammonium salt. TBAC was put into water in the ratio shown in Table 1. The mixture was stirred at 600 rpm for 1 hour using a mechanical stirrer to completely dissolve the TBAC, thereby preparing an aqueous solution. Calcium carbonate was added to this aqueous solution in the ratio shown in Table 1 to obtain a latent heat storage material of Example 1-4.

### Example 1-5

TBAN was used as a quaternary ammonium salt. TBAN was put into water in the ratio shown in Table 1. The mixture was stirred at 600 rpm for 1 hour using a mechanical stirrer to completely dissolve the TBAN, thereby preparing an aqueous solution. Calcium carbonate was added to this aqueous solution in the ratio shown in Table 1 to obtain a latent heat storage material of Example 1-5.

The latent heat storage materials of Examples 1-1 to 1-5 were subjected to XRD measurement at the respective onset temperatures of melting. Diffraction peaks of calcium carbonate were observed, which indicates that calcium carbonate precipitated in the latent heat storage materials of Examples 1-1 to 1-5 at the respective onset temperatures of melting.

### Comparative Example 1-1

A latent heat storage material of Comparative Example 1-1 was obtained by the same procedures as in Example 1-1, except that no calcium carbonate was added.

### Comparative Example 1-2

A latent heat storage material of Comparative Example 1-2 was obtained by the same procedures as in Example 1-2, except that no calcium carbonate was added.

### Comparative Example 1-3

A latent heat storage material of Comparative Example 1-3 was obtained by the same procedures as in Example 1-3, except that no calcium carbonate was added.

### Comparative Example 1-4

A latent heat storage material of Comparative Example 1-4 was obtained by the same procedures as in Example 1-4, except that no calcium carbonate was added.

### Comparative Example 1-5

A latent heat storage material of Comparative Example 1-5 was obtained by the same procedures as in Example 1-5, except that no calcium carbonate was added.

Table 2 shows the temperature T (° C.), onset temperature of melting, and amount of latent heat measured under Condition 1 on each of the latent heat storage materials of Examples 1-1 to 1-5 and Comparative Examples 1-1 to 1-5.

All these examples and comparative examples used 50 grams of base material, which means that when the ratio of calcium carbonate relative to base material (addition ratio of calcium carbonate) was 1 mass %, 0.5 grams of calcium carbonate was added to 50 grams of base material.

TABLE 1

| | | | Molar Ratio to | | Addition Ratio |
|---|---|---|---|---|---|
| | | | Quaternary | | (mass %) of Calcium |
| | Quaternary | | Ammonium Salt | | Carbonate to Entire |
| | Ammonium Salt | Inorganic Salt | Inorganic Salt | Water | Base Material |
| Example 1-1 | TBAB | nil | — | 26.8 | 1 |
| Comparative | TBAB | nil | — | 26.8 | 0 |
| Example 1-1 | | | | | |
| Example 1-2 | TBAB | KBr | 1.30 | 26.3 | 1 |
| Comparative | TBAB | KBr | 1.30 | 26.3 | 0 |
| Example 1-2 | | | | | |
| Example 1-3 | TBAB | KNO₃ | 0.68 | 26.4 | 1 |
| Comparative | TBAB | KNO₃ | 0.68 | 26.4 | 0 |
| Example 1-3 | | | | | |
| Example 1-4 | TBAC | nil | — | 30.0 | 1 |
| Comparative | TBAC | nil | — | 30.0 | 0 |
| Example 1-4 | | | | | |
| Example 1-5 | TBAN | nil | | 37.7 | 1 |
| Comparative | TBAN | nil | — | 37.7 | 0 |
| Example 1-5 | | | | | |

TABLE 2

| | | Onset | |
|---|---|---|---|
| | Temperature | Temperature | |
| | T (° C.) | of Melting | Amount |
| | under | (° C.) from | of Latent |
| | Condition 1 | DSC Experiment | Heat (J/g) |
| Example 1-1 | 0 | 12.0 | 183 |
| Comparative | −5.0 | 11.9 | 190 |
| Example 1-1 | | | |
| Example 1-2 | −8.8 | 3.0 | 182 |
| Comparative | −13.7 | 2.9 | 185 |
| Example 1-2 | | | |
| Example 1-3 | 3.1 | 5.9 | 182 |
| Comparative | −8.4 | 6.0 | 186 |
| Example 1-3 | | | |
| Example 1-4 | −1.9 | 14.9 | 193 |
| Comparative | −3.2 | 15.0 | 204 |
| Example 1-4 | | | |
| Example 1-5 | −6.9 | 3.2 | 170 |
| Comparative | Did not | 3.3 | 170 |
| Example 1-5 | solidify | | |

Table 2 shows that the latent heat storage material of Example 1-1, to which calcium carbonate was added, had an approximately equal onset temperature of melting and amount of latent heat to those of the latent heat storage material of Comparative Example 1-1, to which no calcium carbonate was added and also that the former solidified or had a higher temperature T (C) than the latter. The same tendency was observed in Examples 1-2 to 1-5 as in Example 1-1. It is concluded from these results that the latent heat storage materials of Examples 1-1 to 1-5, to which an aspect of the present invention is applied, retain the cold insulation capability thereof and are still restrained from supercooling.

### Example 1-6

A latent heat storage material of Example 1-6 was obtained by the same procedures as in Example 1-1, except that the addition ratio of calcium carbonate relative to the base material was changed from 1 mass % to 0.1 mass %.

### Example 1-7

A latent heat storage material of Example 1-7 was obtained by the same procedures as in Example 1-1, except that the addition ratio of calcium carbonate relative to the base material was changed from 1 mass % to 0.05 mass %. Calcium carbonate was observed to have precipitated on the bottom of the container in which the latent heat storage material was prepared, which shows that the addition ratio of calcium carbonate in the latent heat storage material of Example 1-7 was higher than the solubility of calcium carbonate in the aqueous solution of Comparative Example 1-1.

### Comparative Example 1-6

A latent heat storage material of Comparative Example 1-6 was obtained by the same procedures as in Example 1-1, except that calcium carbonate was replaced by tricalcium phosphate. Tricalcium phosphate is known to be insoluble in water.

Table 3 shows the temperature T (° C.), onset temperature of melting, and amount of latent heat measured under Condition 3 and Condition 4 on each of the latent heat storage materials of Example 1-6, Example 1-7, and Comparative Example 1-6. Table 3 also shows the temperature T (° C.) measured under Condition 3 and Condition 4 on each of the latent heat storage materials of Example 1-1 and Comparative Example 1-1.

TABLE 3

| | | | Onset | |
|---|---|---|---|---|
| | Temperature | Temperature | Temperature | |
| | T (° C.) | T (° C.) | of Melting | Amount |
| | under | under | (° C.) from | of Latent |
| | Condition 3 | Condition 4 | DSC Experiment | Heat (J/g) |
| Example 1-1 | 6.0 | 6.0 | 12.0 | 183 |
| Comparative | Did not | Did not | 11.9 | 190 |
| Example 1-1 | solidify | solidify | | |
| Example 1-6 | 5.0 | 5.0 | 11.9 | 183 |
| Example 1-7 | Did not | 3.9 | 11.9 | 184 |
| | solidify | | | |
| Comparative | Did not | Did not | 11.9 | 180 |
| Example 1-6 | solidify | solidify | | |

Table 3 shows that the latent heat storage material of Example 1-6, where the addition ratio of calcium carbonate relative to the base material was changed from 1 mass % (Example 1-1) to 0.1 mass %, still solidified in a 3° C. (Condition 4) or 5° C. (Condition 3) environment. Table 3 also shows that the latent heat storage material of Example 1-7, where the addition ratio of calcium carbonate relative to the base material was changed from 0.1 mass % (Example 1-6) to 0.05 mass %, still solidified in a 3° C. environment.

It is concluded from these results that the latent heat storage material can be frozen in a 3° C. environment when the addition ratio of calcium carbonate in the latent heat storage material is 0.05 mass % or higher and also that the latent heat storage material can be frozen in a 5° C. environment when the addition ratio of calcium carbonate in the latent heat storage material is 0.1 mass % or higher. A typical refrigeration room of a refrigerator is 5° C. The addition ratio of calcium carbonate in the latent heat storage material is therefore preferably 0.1 mass % or higher for stable solidification of the latent heat storage material.

The latent heat storage material of Comparative Example 1-1 did not solidify under Condition 3.

The latent heat storage materials of Example 1-6 and Example 1-7 had an approximately equal onset temperature of melting and amount of latent heat to those of the latent heat storage material of Comparative Example 1-1.

It is concluded from these results that the latent heat storage material of Example 1-6, where the addition ratio of calcium carbonate was 0.1 mass %, retains the cold insulation capability thereof and is still restrained from supercooling and also that the latent heat storage material of Example 1-7, where the addition ratio of calcium carbonate was 0.05 mass %, restrains the cold insulation capability thereof and is still restrained from supercooling.

The latent heat storage material of Comparative Example 1-6 did not solidify under Condition 3. It is understood from these results that the additive to the base material exhibits no supercooling inhibiting effect if the additive is only poorly soluble or insoluble at all in water.

In an aspect of the present invention, it would be important to combine the base material and the additive in such a manner that the additive to the base material can achieve sufficient supercooling inhibiting effect. More specifically, it would be important that the base material has a small contact angle on the additive. In relation to this respect, water has a small contact angle on calcium carbonate, which is used in an aspect of the present invention. This small contact angle would promote the nucleation of calcium carbonate, which would in turn promote the formation of a clathrate hydrate of a quaternary ammonium salt. The latent heat storage material in an aspect of the present invention would be restrained from supercooling for these reasons.

### Evaluation of Restrained Supercooling in Cold Storage Pack

### Example 2-1

TBAB (18.4 kilograms) as a quaternary ammonium salt and potassium carbonate (0.346 kilograms) as a soluble carbonate salt were dissolved in water (16.4 kilograms) to prepare an aqueous carbonate salt solution.

Next, potassium nitrate (3.53 kilograms) as an inorganic salt and calcium nitrate tetrahydrate (0.590 kilograms) as a soluble calcium salt were dissolved in water (11 kilograms) to prepare an aqueous calcium salt solution.

A container (capacity: 550 grams) was prepared that had a similar structure to the cold storage pack main body 110 shown in FIGS. 1 and 2. After pouring the aqueous carbonate salt solution (350 grams) into the container, the aqueous calcium salt solution (151 grams) was poured. The aqueous carbonate salt solution started to become cloudy immediately after the calcium salt was poured into the aqueous carbonate salt solution, which indicates that salt had been exchanged between potassium carbonate and calcium nitrate tetrahydrate, thereby forming calcium carbonate. A cold storage pack of Example 2-1 was prepared in this manner.

A latent heat storage material for this cold storage pack was subjected in the solid state to measurement of an X-ray diffraction pattern using X-ray diffraction apparatus equipped with a temperature control function. The obtained X-ray diffraction pattern was checked for an X-ray diffraction peak of calcium carbonate to verify the formation of calcium carbonate.

A latent heat storage material for the cold storage pack of Example 2-1 was subjected to measurement under Condition 2 to obtain temperature T (° C.), which is shown in Table 4. The latent heat storage materials of Example 1-3 and Comparative Example 1-3 were subjected to measurement under Condition 2 to obtain temperature T (° C.), which is also shown in Table 4.

TABLE 4

| | Temperature T (° C.) under Condition 2 |
|---|---|
| Example 2-1 | 2.6 |
| Example 1-3 | 0.5 |
| Comparative | 0.1 |
| Example 1-3 | |

Table 4 shows that the latent heat storage material of Example 2-1 which formed calcium carbonate in the reaction system exhibited a better supercooling inhibiting effect than the latent heat storage material of Example 1-3 to which calcium carbonate was added in powder form to a TBAB-containing aqueous solution.

The precipitation rates of calcium carbonate were compared to examine reasons why there existed a difference in supercooling inhibiting effect between the latent heat storage material of Example 2-1 and the latent heat storage material of Example 1-3. The precipitation rates of calcium carbonate were compared by shaking the cold storage packs, letting the cold storage packs to sit, and visually observing precipitation of calcium carbonate in the cold storage packs.

It was observed that calcium carbonate precipitated more quickly in the latent heat storage material of Example 2-1 than in the latent heat storage material of Example 1-3. It is inferred from this result that the calcium carbonate formed in the reaction system in Example 2-1 had a larger particle diameter than the calcium carbonate in powder form used in Example 1-3. In other words, the surface area per crystal of calcium carbonate was more likely to increase in Example 2-1 than in Example 1-3. Since the nucleation of a clathrate hydrate of a quaternary ammonium salt occurs on the surface of calcium carbonate as described above, nuclei of the clathrate hydrate of the quaternary ammonium salt are therefore more likely to form, which would explain why the latent heat storage material of Example 2-1 exhibited better supercooling inhibiting effect than the latent heat storage material of Example 1-3 to which calcium carbonate was added in powder form to a TBAB-containing aqueous solution.

The following will describe a refrigerator in which the latent heat storage materials described above are used, with reference to FIG. 21.

### Evaluation of Restrained Supercooling in Refrigerator

### Example 3-1

The latent heat storage material of Example 1-1 was poured into a container that was similar to the one used in Example 2-1 to prepare a cold storage pack. Next, the prepared cold storage pack was placed in a refrigerator (capacity: 144 L) that was similar to the refrigerator main body 810 shown in FIG. 21. The cold storage pack was positioned 65 cm above the bottom of the refrigerator main body. The refrigerator had an inside temperature of 3° C. before the cold storage pack was placed therein. The inside temperature was measured in accordance with JIS C9801: 2006. It was observed that the latent heat storage material solidified 18 hours after the refrigeration cold storage pack was placed inside the refrigerator.

### Example 3-2

The same procedures were carried out as in Example 3-1, except that the latent heat storage material of Example 1-3 was used in place of the latent heat storage material of Example 1-1. It was observed that the latent heat storage material solidified 25 hours after the prepared cold storage pack was placed inside the refrigerator.

### Comparative Example 3-1

The same procedures were carried out as in Example 3-1, except that the latent heat storage material of Comparative Example 1-1 was used in place of the latent heat storage material of Example 1-1. It was observed that the latent heat storage material did not still solidify 18 hours after the prepared cold storage pack was placed inside the refrigerator.

### Comparative Example 3-2

The same procedures were carried out as in Example 3-1, except that the latent heat storage material of Comparative Example 1-3 was used in place of the latent heat storage material of Example 1-1. It was observed that the latent heat storage material did not still solidify 18 hours after the cold storage pack was placed in the refrigerator.

It is concluded from these results that the refrigerator using the cold storage pack to which an aspect of the present invention is applied is capable of solidifying the latent heat storage material in the cold storage pack.

### Evaluation of Cooling in Refrigerator

Next, after the latent heat storage materials of Example 3-1 and Example 3-2 solidified, the refrigerator was powered off assuming a power failure, and time was measured starting at the power off until the inside temperature reached 10° C. A comparison was made with a refrigerator using no cold storage pack.

The inside temperature of the refrigerator of Example 3-1 reached 10° C. in 84 minutes. The inside temperature of the refrigerator of Example 3-2 reached 10° C. in 90 minutes.

In contrast, the inside temperature of the refrigerator using no cold storage pack reached 10° C. in 63 minutes.

It is concluded from these results that the refrigerator using the cold storage pack to which an aspect of the present invention is applied is capable of maintaining a temperature of 10° C. or lower, which is a temperature suitable for the refrigeration of refrigerated articles, for a longer period of time than the refrigerator using no cold storage pack.

The discussion so far demonstrates that the present invention is useful.

1. A latent heat storage material comprising:
quaternary ammonium ions and first anions that together form a quaternary ammonium salt;
water; and
calcium carbonate, wherein
the quaternary ammonium salt and the water can form a clathrate hydrate,
the quaternary ammonium salt and the water have a composition ratio in which the quaternary ammonium salt and the water can at least form the clathrate hydrate, and
the calcium carbonate has an addition ratio relative to a mass of an aqueous solution that is the latent heat storage material excluding the calcium carbonate, the addition ratio being higher than a solubility of the calcium carbonate in the aqueous solution at an onset temperature of melting of the aqueous solution that is the latent heat storage material excluding the calcium carbonate.

2. The latent heat storage material according to claim 1, wherein the quaternary ammonium salt is at least one compound selected from the group consisting of tetrabutylammonium fluoride, tetrabutylammonium bromide, tetrabutylammonium chloride, and tetrabutylammonium nitrate.

3. The latent heat storage material according to claim 1, wherein the calcium carbonate has an addition ratio of at least 0.1 mass % relative to a sum of the quaternary ammonium salt and the water.

4. The latent heat storage material according to claim 2, wherein
the quaternary ammonium salt is tetrabutylammonium bromide, and
the calcium carbonate has an addition ratio of at least 0.1 mass % relative to a sum of the tetrabutylammonium bromide and the water.

5. The latent heat storage material according to claim 1, further comprising metal ions (M⁺) and second anions (Xⁿ⁻) that together form an inorganic salt of formula (1), wherein the inorganic salt has a molar ratio of from 0.1 to 10, both inclusive, relative to the quaternary ammonium salt:
M⁺ₙXⁿ⁻ (1),
where M⁺ represents K⁺, Rb⁺, or Cs⁺, and Xⁿ⁻ represents F⁻, Cl⁻, Br⁻, I⁻, NO₃⁻, or PO₄³⁻.

6. The latent heat storage material according to claim 5, wherein the second anions are at least one type of ions selected from the group consisting of fluoride ions, chloride ions, bromide ions, iodide ions, and nitrate ions.

7. The latent heat storage material according to claim 5, wherein the metal ions are potassium ions.

8. The latent heat storage material according to claim 5, wherein
the quaternary ammonium salt is tetrabutylammonium bromide,
the inorganic salt is potassium bromide, and
the calcium carbonate has an addition ratio of at least 0.1 mass % relative to a sum of the tetrabutylammonium bromide, the water, and the potassium bromide.

9. The latent heat storage material according to claim 5, wherein
the quaternary ammonium salt is tetrabutylammonium bromide,
the inorganic salt is potassium nitrate, and
the calcium carbonate has an addition ratio of at least 0.1 mass % relative to a sum of the tetrabutylammonium bromide, the water, and the potassium nitrate.

10. A cold storage pack comprising
the latent heat storage material according to claim 1; and
at least one encasing section configured to encase the latent heat storage material therein in a liquid-tight manner.

11. The cold storage pack according to claim 10, wherein
the at least one encasing section includes a plurality of such encasing sections, and
the cold storage pack further comprises an articulation section configured to connect the plurality of encasing sections to each other.

12. A logistic packaging container comprising the cold storage pack according to claim 10.

13. The logistic packaging container according to claim 12, further comprising a holding member configured to hold the cold storage pack.

14. A logistic packaging container comprising the cold storage pack according to claim 11.

15. A human body cooling tool comprising the cold storage pack according to claim 10.

16. A human body cooling tool comprising the cold storage pack according to claim 11.

17. A food cooling tool comprising the cold storage pack according to claim 10.

18. A food cooling tool comprising the cold storage pack according to claim 11.

19. A refrigerator comprising the cold storage pack according to claim 10.

20. A refrigerator comprising the cold storage pack according to claim 11.

21. A method of manufacturing a latent heat storage material, the method comprising mixing an aqueous solution of a carbonate salt and an aqueous solution of a calcium salt, wherein either one or both of the aqueous solution of a carbonate salt and the aqueous solution of a calcium salt contain(s) a quaternary ammonium salt.

22. The method of manufacturing the latent heat storage material according to claim 21, wherein
the carbonate salt is an inorganic salt of formula (2), and
the calcium salt is an inorganic salt of formula (3):
M⁺₂CO₃²⁻ (2),
Ca²⁺_{(n/2)}Xⁿ⁻ (3),
where M⁺ in formula (2) represents K⁺, Rb⁺, or Cs⁺, and Xⁿ⁻ in formula (3) represents F⁻, Cl⁻, Br⁻, I⁻, NO₃⁻, or PO₄³⁻.
